(19) United States
(12) Patent Application Publication
(10) Pub. No.: US 2024/0354739 A1
(43) Pub. Date: Oct. 24, 2024

(54) CARD BINDING METHOD, USER TERMINAL, SERVER, SYSTEM AND STORAGE MEDIUM

(71) Applicant: CHINA UNIONPAY CO., LTD., Pudong New Area Shanghai (CN)

(72) Inventors: Jianbo CAI, Pudong New Area Shanghai (CN); Changsheng SHAN, Pudong New Area Shanghai (CN); Dezhong NI, Pudong New Area Shanghai (CN); Yuhang GUO, Pudong New Area Shanghai (CN); Chenyu PAN, Pudong New Area Shanghai (CN); Rui LU, Pudong New Area Shanghai (CN)

(21) Appl. No.: 18/683,493

(22) PCT Filed: Feb. 15, 2022
(86) PCT No.: PCT/CN2022/076375

§ 371 Date: Feb. 13, 2024

(30) Foreign Application Priority Data
Sep. 6, 2021 (CN) 202111038223.3

(51) Int. Cl. G06Q 20/34

(52) U.S. Cl. CPC G06Q 20/34

(57) ABSTRACT

The present application provides a card binding method, a user terminal, a server, a card binding system and a storage medium. The method includes accepting an access from a user terminal to a first page address indicated by the user terminal calling a first application to scan an information carrier pattern, and acquiring a card number of a target card; acquiring user information about a target user from a back-end server of the first application; sending, to the user terminal, a second page address corresponding to a redirected card binding page; receiving a card binding confirmation message indicating identity information about the target user; and interacting with a card issuing server and a back-end server of a card binding application by using the identity information, to complete a binding between a card identifier of the target card and a user identifier of the target user in the card binding application.

### CROSS-REFERENCE TO RELATED APPLICATION

The application is a National Stage of International Application No. PCT/CN2022/076375, filed on Feb. 15, 2022, which claims priority to Chinese Patent Application No. 202111038223.3, filed on Sep. 6, 2021 and entitled “CARD BINDING METHOD, USER TERMINAL, SERVER, SYSTEM AND STORAGE MEDIUM”, both of which are hereby incorporated by reference in their entireties.

### TECHNICAL FIELD

The present application is related to the field of data processing, and particularly, to a card binding method, a user terminal, a server, a system and a storage medium.

### BACKGROUND

With the continuous development of electronic information technology, electronic payment is applied to more and more areas. A user may achieve electronic payment with a bank card by operating an application in a user terminal.

A bank card should be bound to a user account of an application before the bank card is used to achieve electronic payment through the application. However, due to the diversities of applications, different applications have different settings for guiding entries of a card binding function, and it is not easy to locate the guiding entries of the card binding function in the applications, and thus it takes a relatively long time for a user to locate the guiding entries of the card binding function in the applications, leading to a reduction in the efficiency of the user using the application to bind the card.

### SUMMARY

Embodiments of the present application provide a card binding method, a user terminal, a server, a system and a storage medium, which can improve the efficiency of using an application to bind a card.

In a first aspect, an embodiment of the present application provides a card binding method applicable to a card binding server. The method includes accepting an access from a user terminal to a first page address indicated by the user terminal calling a first application to scan an information carrier pattern, and acquiring a card number of a target card indicated by the information carrier pattern: acquiring user information about a target user from a back-end server of the first application, wherein the target user is a user logging onto the first application, and the user information includes a user identifier of the target user in the first application; sending, to the user terminal, a second page address corresponding to a redirected card binding page, wherein the card binding page includes at least a part of the card number of the target card: receiving a card binding confirmation message indicating identity information about the target user, wherein the card binding confirmation message is sent by the user terminal based on the card binding page; and interacting with a card issuing server and a back-end server of a card binding application by using the identity information, to complete a binding between a card identifier of the target card and a user identifier of the target user in the card binding application, wherein the card binding application includes the first application.

In a second aspect, an embodiment of the present application provides a card binding method applicable to a user terminal. The method includes calling a first application to scan an information carrier pattern, accessing a first page address of a card binding server indicated by the information carrier pattern, and sending a card number of a target card indicated by the information carrier pattern to the card binding server, so as to trigger the card binding server to acquire user information about a target user from a back-end server of the first application, wherein the target user is a user logging onto the first application, and the user information includes a user identifier of the target user in the first application: receiving and accessing a second page address sent by the card binding server, to display a card binding page corresponding to the second page address and including at least a part of the card number of the target card: sending, in response to a user input to the card binding page, a card binding confirmation message indicating identity information about the target user, to the card binding server, enabling the card binding server to interact with a card issuing server and a back-end server of a card binding application by using the identity information, to complete a binding between a card identifier of the target card and a user identifier of the target user in the card binding application, wherein the card binding application includes the first application.

In a third aspect, an embodiment of the present application provides a card binding method applicable to a back-end server of an application. The method includes under a condition that the application is a first application and a card binding server accepts an access from a user terminal to a first page address indicated by the user terminal calling the first application to scan an information carrier pattern, sending a user information about a target user to the card binding server, wherein the target user is a user logging onto the first application, and the user information includes a user identifier of the target user in the first application; and under a condition that the card binding server receives a card binding confirmation message, interacting with the card binding server to complete a binding between a card identifier of a target card and the user identifier of the target user in the first application, wherein the card binding confirmation message is sent by the user terminal in response to a user input to a card binding page and is used to indicate identity information about the target user, the card binding page includes at least a part of a card number of the target card, and a card binding application includes the first application.

In a fourth aspect, an embodiment of the present application provides a server, including an interaction module including a receiving unit and a sending unit: the interaction module being configured to accept an access from a user terminal to a first page address indicated by the user terminal calling a first application to scan an information carrier pattern, acquire a card number of a target card indicated by the information carrier pattern, and acquire user information about a target user from a back-end server of the first application, wherein the target user is a user logging onto the first application, and the user information includes a user identifier of the target user in the first application: the sending unit being configured to send, to the user terminal, a second page address corresponding to a redirected card binding page, the redirected card binding page including at least a part of the card number of the target card; the receiving unit being further configured to receive a card binding confirmation message indicating identity information about the target user, wherein the card binding confirmation message is sent by the user terminal based on the card binding page; and the interaction module being further configured to interact with a card issuing server and a back-end server of a card binding application by using the identity information, to complete a binding between a card identifier of the target card and a user identifier of the target user in the card binding application, wherein the card binding application includes the first application.

In a fifth aspect, an embodiment of the present application provides a user terminal, including a scanning module, an interaction module including a sending unit, and a display module: the scanning module being configured to scan an information carrier pattern under a condition that a first application is called: the interaction module being configured to access a first page address of a card binding server indicated by the scanned information carrier pattern, and send, to the card binding server, a card number of a target card indicated by the information carrier pattern, so as to trigger the card binding server to acquire user information about a target user from a back-end server of the first application, wherein the target user is a user logging onto the first application, and the user information includes a user identifier of the target user in the first application: the interaction module being configured to receive and access a second page address sent by the card binding server: the display module being configured to display a card binding page corresponding to the second page address and including at least a part of the card number of the target card; and the sending unit being further configured to send, in response to a user input to the card binding page, a card binding confirmation message indicating identity information about the target user, to the card binding server, enabling the card binding server to interact with a card issuing server and a back-end server of a card binding application by using the identity information, to complete a binding between a card identifier of the target card and a user identifier of the target user in the card binding application, wherein the card binding application includes the first application.

In a sixth aspect, an embodiment of the present application provides a server, including an interaction module including a sending unit: the sending unit being configured to send, under a condition that an application is a first application and a card binding server accepts an access from a user terminal to a first page address indicated by the user terminal calling the first application to scan an information carrier pattern, a user information about a target user to a card binding server, wherein the target user is a user logging onto the first application, and the user information includes a user identifier of the target user in the first application; and the interaction module being configured to interact, under a condition that the card binding server receives a card binding confirmation message, with the card binding server to complete a binding between a card identifier of a target card and the user identifier of the target user in the first application, wherein the card binding confirmation message is sent by the user terminal in response to a user input to a card binding page and is used to indicate identity information about the target user, the card binding page includes at least a part of a card number of the target card, and a card binding application includes the first application.

In a seventh aspect, an embodiment of the present application provides a server, including a processor, and a memory storing computer program instructions, wherein the processor, when executing the computer program instructions, implements the card binding method according to the first aspect.

In an eighth aspect, an embodiment of the present application provides a user terminal, including a processor, and a memory storing computer program instructions, wherein the processor, when executing the computer program instructions, implements the card binding method according to the second aspect.

In a ninth aspect, an embodiment of the present application provides a server, including a processor, and a memory storing computer program instructions, wherein the processor, when executing the computer program instructions, implements the card binding method according to the third aspect.

In a tenth aspect, an embodiment of the present application provides a card binding system, including the server according to the seventh aspect, the user terminal according to the eighth aspect, and the server according to the ninth aspect.

In an eleventh aspect, an embodiment of the present application provides a computer readable storage medium having computer program instructions stored thereon, which when executed by a processor, cause the card binding method according to the first aspect, the card binding method according to the second aspect, or the card binding method according to the third aspect to be implemented.

With the card binding methods, user terminal, servers, system and storage medium provided by embodiments of the present application, the user terminal calls the first application to scan the information carrier pattern, so as to trigger the access to the first page address of the card binding server indicated by the information carrier pattern; and sends the card number of the target card indicated by the scanned information carrier pattern to the card binding server, so as to trigger the card binding server to acquire, from the back-end server of the first application, the user information about the target user who is a user logging onto the first application. The user terminal receives and accesses the second page address corresponding to the card binding page, and displays the card binding page. The user terminal sends identity information confirmed by the user to the card binding server through the card binding confirmation message, so that the card binding server completes the binding between the card identifier of the target card and the user identifier of the target user in the card binding application through the interaction with the card issuing server and the back-end server of the card binding application. It is not necessary for the user to look for a guiding entry of the card binding function in the application, and the card can be bound directly by using a scanning function of the user terminal to jump to the card binding page, thereby reducing the time required for the user to bind the card and improving the efficiency of the user using the application to bind the card.

### BRIEF DESCRIPTION OF THE DRAWINGS

In order to illustrate technical solutions of embodiments of the present application more clearly, the drawings required for the embodiments of the present application will be briefly described below: For a person of ordinary skills in the art, other drawings can be obtained from these drawings without any inventive effort.

FIG. 1 is a schematic view of an example of an application scenario of a card binding method in an embodiment of the present application;

FIG. 2 is a flowchart of an embodiment of a card binding method according to a first aspect of the present application:

FIG. 3 is a schematic view of an example of a card binding page displayed on a user terminal according to an embodiment of the present application:

FIG. 4 is a flowchart of another embodiment of the card binding method according to the first aspect of the present application:

FIG. 5 is a schematic view of another example of a card binding page displayed on a user terminal according to an embodiment of the present application:

FIG. 6 is a schematic view of another example of a card binding page displayed on a user terminal according to an embodiment of the present application:

FIG. 7 is a schematic view of another example of a card binding page displayed on a user terminal according to an embodiment of the present application:

FIG. 8 is a flowchart of another embodiment of the card binding method according to the first aspect of the present application:

FIG. 9 is a flowchart of another embodiment of the card binding method according to the first aspect of the present application:

FIG. 10 is a flowchart of an embodiment of a card binding method according to a second aspect of the present application:

FIG. 11 is a flowchart of another embodiment of the card binding method according to the second aspect of the present application:

FIG. 12 is a flowchart of an embodiment of a card binding method according to a third aspect of the present application:

FIG. 13 is a flowchart of another embodiment of the card binding method according to the third aspect of the present application:

FIG. 14 is a flowchart of another embodiment of the card binding method according to the third aspect of the present application:

FIG. 15 is a flowchart of another embodiment of the card binding method according to the third aspect of the present application:

FIG. 16 is a flowchart of an example of a card binding process according to an embodiment of the present application:

FIG. 17 is a schematic structural view of an embodiment of a server according to a fourth aspect of the present application;

FIG. 18 is a schematic structural view of another embodiment of the server according to the fourth aspect of the present application:

FIG. 19 is a schematic structural view of another embodiment of the server according to the fourth aspect of the present application:

FIG. 20 is a schematic structural view of another embodiment of the server according to the fourth aspect of the present application:

FIG. 21 is a schematic structural view of an embodiment of a user terminal according to a fifth aspect of the present application:

FIG. 22 is a schematic structural view of an embodiment of a server according to a sixth aspect of the present application:

FIG. 23 is a schematic structural view of another embodiment of the server according to the sixth aspect of the present application:

FIG. 24 is a schematic structural view of another embodiment of the server according to the sixth aspect of the present application:

FIG. 25 is a schematic structural view of an embodiment of a server according to a seventh aspect of the present application:

FIG. 26 is a schematic structural view of an embodiment of a user terminal according to an eighth aspect of the present application:

FIG. 27 is a schematic structural view of an embodiment of a server according to a ninth aspect of the present application.

### DETAILED DESCRIPTION

Features and exemplary embodiments of various aspects of the present application will be described in details below: In order to make the objects, technical solutions and advantages of the present application clearer, the present application is further described in details below with reference to the drawings and specific embodiments. It should be understood that the specific embodiments described herein are only used to explain the present application, but not to limit the present application. For those skilled in the art, the present application can be implemented without some of these specific details. The following description of the embodiments is only to provide a better understanding of the present application by illustrating examples of the present application.

With the continuous development of electronic information technology, electronic payment is applied to more and more areas. A user may achieve electronic payment with a bank card by operating an application (APP) in a user terminal. A bank card should be bound to a user account of an application before the bank card is used to achieve electronic payment through the application, so that the bank card bound to the user account in the application can be used for payment when the user account is logged on to use the application, payment may be made using the bank card bound with the user account in the application. However, it is difficult for the user to locate a guiding entry of a card binding function in an application, and different applications have different settings for guiding entries of the card binding function, so it takes a relatively long time for the user to locate the guiding entries of the card binding function in the applications, leading to a reduction in the efficiency of the user using the application to bind the card.

Embodiments of the present application provide a card binding method, a user terminal, a server, a system and a storage medium, which allows a user to bond a card directly by using a scanning function of a user terminal to jump to a card binding page in no need of looking for a guiding entry of the card binding function in an application, thereby reducing the time required for the user to bind the card and improving the efficiency of the user using the application to bind the card.

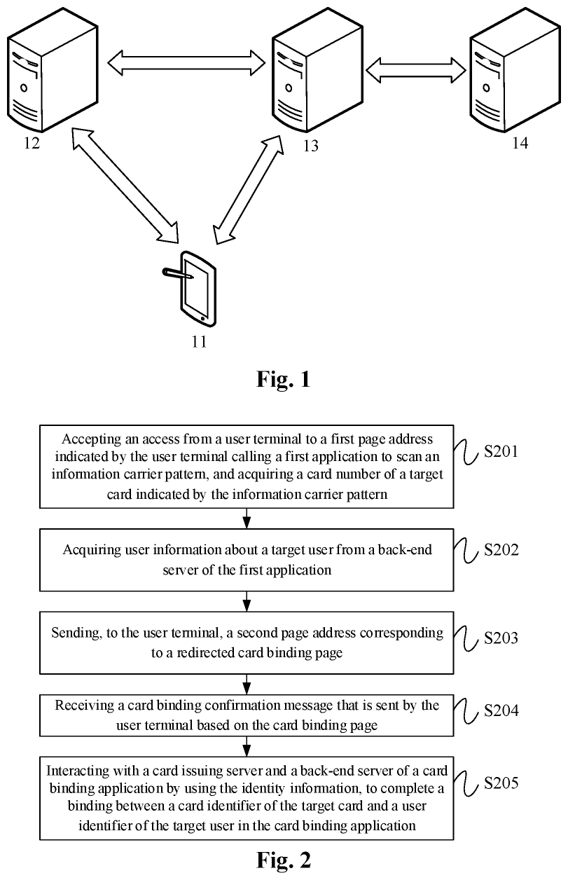

Card binding methods in embodiments of the present application may involve a user terminal, a back-end server of each application, a card binding server, and a card issuing server. FIG. 1 is a schematic view of an example of an application scenario of a card binding method in an embodiment of the present application. As shown in FIG. 1, a user terminal 11 can communicate and interact with a back-end server 12 of each application and also a card binding server 13, and the card binding server 13 can communicate and interact with the back-end server 12 of each application and also a card issuing server 14. In FIG. 1, in order to distinguish back-end servers of different applications, the back-end servers corresponding to the different applications are represented by different reference numbers. The back-end server 121 is a back-end server for an application A1, the back-end server 122 is a back-end server for an application A2, and the back-end server 123 is a back-end server for an application A3.

A human-computer interaction may be performed between the user terminal 11 and a user. More than two applications may be installed on the user terminal 11. Specifically, the user terminal 11 may include a terminal device such as a mobile phone, a tablet computer, and the like, which is not limited herein.

The back-end server 12 is a back-end server for an application. Different applications may be serviced by different back-end servers or the same back-end server, which is not limited herein. By interacting with the user terminal 11, the back-end server 12 can provide information or the like required by a corresponding application in the user terminal 11, and receive an instruction or the like that is sent by the corresponding application through the user terminal 11.

The card binding server 13 may provide a card binding function. In the embodiment of the present application, by interacting with the user terminal 11, the card binding server 13 may provide the user terminal with a card binding page for using by the user to perform a further card binding operation at the user terminal, and also acquire information fed back by the user terminal 11. By interacting with the back-end server 12 of the application, the card binding server 13 may obtain information required for the card binding from the back-end server 12 of the application.

The card issuing server 14 is a server of a card issuer, and records information about a bank card, information about a user holding the card, and the like. The card issuing server 14 may interact with the card binding server 13 to perform an identity verification on a bank card and a user corresponding to the information provided by the card binding server.

The card binding methods, user terminal, servers, system and storage medium according to the embodiments of the present application will be described below in sequence.

A first aspect of the present application provides a card binding method applicable to a card binding server, that is, the card binding method may be performed by the card binding server. FIG. 2 is a flowchart of an embodiment of the card binding method according to the first aspect of the present application. As shown in FIG. 2, the card binding method may include steps S201 to S205.

In step S201, an access from a user terminal to a first page address indicated by the user terminal calling a first application to scan an information carrier pattern is accepted, and a card number of a target card indicated by the information carrier pattern is acquired.

The information carrier pattern may be used as a carrier for the first page address and the card number of the target card. Under a condition that a user logs into the first application of the user terminal, the user terminal calls the first application to scan the information carrier pattern to obtain the first page address and the card number of the target card.

A form of the information carrier pattern is not limited in embodiments of the present application. In some examples, the information carrier pattern may include a Quick Response (QR) code. Information recorded by the QR code may include the first page address and the card number of the target card. That is, the user terminal calls the first application to scan the QR code to obtain the first page address and the card number of the target card. The user terminal may jump to access the first page address and send the card number of the target card to the card binding server. Correspondingly, the card binding server may accept the access from the user terminal to the first page address, and receive the card number of the target card sent by the user terminal.

In some other examples, the information carrier pattern may include the QR code. Information recorded by the QR code may include the first page address and an encrypted card number of the target card. Specifically, the encrypted card number of the target card is the card number of the target card in the embodiment encrypted with a first key. The user terminal may jump to access the first page address and send the encrypted card number of the target card to the card binding server. Correspondingly, the card binding server accepts the access from the user terminal to the first page address and receives the encrypted card number of the target card.

Specifically, the QR code in the above example may use a card as a carrier (that is, the QR code may be printed on a surface of the card), use paper as a carrier, (that is, the QR code may be printed on the paper), or may be displayed in the form of an electronic QR code, which is not limited herein. The QR code may be generated by an owner of the card issuing server according to a standard, and provided to a cardholder. The QR code may also be generated by an owner of the card binding server according to a standard, and provided to the cardholder through an interface.

In some other examples, the information carrier pattern may include a surface pattern of the target card. The surface pattern may include a page jump mark and the card number of the target card. The page jump mark may be a particular pattern, which is not limited herein. The user terminal may store the first page address corresponding to the page jump mark, and when the user terminal calls the first application to scan the page jump mark, the access to the first page address is triggered. The user terminal may send the card number of the target card directly to the card binding server, that is, the card binding server acquires the card number of the target card from the user terminal. Alternatively, the user terminal may encrypt the card number of the target card with the first key, and send the encrypted card number of the target card to the card binding server, that is, the card binding server acquires the encrypted card number of the target card from the user terminal.

The information carrier pattern carries the first page address and the card number of the target card, so that the user terminal may directly access the first page address to initiate the card binding operation by calling the first application to scan the information carrier pattern, and there is no need for the user to look for an entry of a card binding service in the first application, thereby further reducing the user's operation in the card binding process.

The first page address is a page address of the card binding server. The first page address may be the same page address for different users, different applications, and different user terminals. For example, the same user may log onto a plurality of different applications on the same user terminal, and may access the same page address. (i.e., the first page address), by jumping through the different applications of the user terminal. As another example, different users may log onto the same application on different user terminals, and may access the same page address (i.e., the first page address), by jump through the application of the different user terminals. As another example, different users may log onto different applications on different user terminals, and may access the same page address (i.e., the first page address), by jumping through the different applications of the different user terminals.

An execution timing relationship between the user terminal accessing the first page address and sending the card number of the target card to the card binding server is not limited herein, that is, an execution timing relationship between the card binding server accepting the access from the user terminal to the first page address and acquiring the card number of the target card from the user terminal. In some examples, the user terminal may send the card number of the target card to the card binding server while accessing the first page address, so that the card binding server acquires the card number of the target card from the user terminal. In some other examples, the user terminal may access the first page address and send the card number of the target card to the card binding server in sequence.

The target card may be a card to be bound. The target card may include any card capable of making a payment such as a bank card, a membership card, and the like, which is not limited herein.

In some examples, the card binding server acquires the encrypted card number of the target card from the user terminal. Correspondingly, the card binding server needs to decrypt the encrypted card number of the target card, so as to acquire the card number of the target card. Specifically, the card binding server receives the card number of the target card that is sent by the user terminal and encrypted with the first key. The card binding server decrypts the encrypted card number of the target card using a pre-stored second key paired with the first key, to obtain the card number of the target card. The first key and the second key may be symmetric keys, that is, the first key and the second key are the same. The first key and the second key may also be asymmetric keys, that is, the first key and the second key are different. Particular types of the first key and the second key are not limited herein.

By sending the card number of the target card in an encrypted way, the risk of leakage of the card number of the target card can be reduced, the security of the card number of the target card can be ensured, so as to improve the security of the card binding process.

In step S202, the user information about a target user is acquired from a back-end server of the first application.

The card binding server acquires the user information about the target user from the back-end server of the first application, in response to the access from the user terminal to the first page address. The user terminal accesses the first page address by jumping through the first application, and the card binding server may determine the application accessing the first page address and the user logging onto the application. The target user is a user logging onto the first application.

Specifically, the card binding server may send a user information request message to the back-end server of the first application, in response to the access from the user terminal to the first page address. The user information request message is used to request, from the back-end server of the first application, the user information about the target user. The back-end server of the first application feeds back the user information about the target user to the card binding server, in response to the user information request message. In some examples, the user information request message may include a temporary identifier of the target user, and the back-end server of the first application may determine the target user according to the temporary identification.

The user information may include a user identifier of the target user in the first application. The user identifier of the target user in the first application is used to identify the target user in the first application. The user identifier may be a user registration account number, a user registration number, a user registration name, and the like, which is not limited herein. User identifiers of the same target user in different applications may be the same or different, which is not limited herein.

The user information may further include other information, which is not limited herein. In some examples, the user information may further include identity information. Identity information about the target user may be information that characterizes the target user's personal identity. For example, the identity information may include, but is not limited to, one or more of a name, an identification document number, a mobile phone number, a mailbox address, and the like.

In some examples, the card binding server may perform a verification on the first application firstly, and then determine whether to acquire the user information about the target user from the back-end server of the first application. Specifically, after accepting the access from the user terminal to the first page address through the first application, and acquiring the card number of the target card from the user terminal, the card binding server may determine whether the first application belongs to applications supported by the card binding server firstly. Under a condition that the first application belongs to the applications supported by the card binding server, the card binding server acquires the user information about the target user from the back-end server of the first application. Under a condition that the first application does not belong to the applications supported by the card binding server, the card binding server will not acquire the user information about the target user from the back-end server of the first application. The applications supported by the card binding server are applications in a white list. By determining in advance whether the first application is supported by the card binding server, it can be avoided to bind a card with an illegal application or a unqualified application, thereby ensuring the security and reliability of card binding.

In step S203, a second page address corresponding to a redirected card binding page is sent to the user terminal.

Under a condition that the card binding server acquires the user information about the target user, the card binding server may redirect the page address accessed by the user terminal. The card binding server can send, to the user terminal, the second page address corresponding to the card binding page, so that the user terminal accesses the second page address and displays the card binding page. Resource information included in the card binding page is provided by the card binding server.

In some examples, the card binding page may include at least a part of the card number of the target card. The card number of the target card is the card number of the target card acquired in step S201. The card binding page may include a complete card number of the target card, or may include a card number of the target card with partial symbol(s) hidden, which is not limited herein. For example, the card binding page may include a card number with middle four symbols hidden.

The card binding page may include at least a part of the card number of the target card, and there is thus no need for a user to input the card number of the target card manually, so as to avoid a potential error that may occur when the card number is input manually. User operations in the card binding process can be reduced, and thereby the success rate of the card binding can be improved and the card binding process can be simplified.

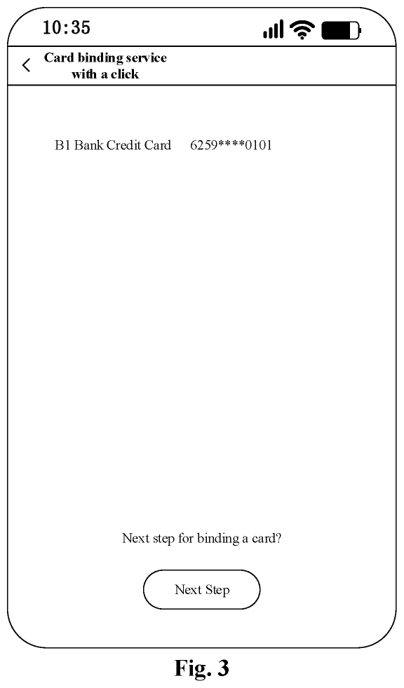

For example, FIG. 3 is a schematic view of an example of a card binding page displayed on a user terminal according to an embodiment of the present application. As shown in FIG. 3, the card binding page includes a card number 6259****0101 of the target card with middle four symbols hidden.

In step S204, a card binding confirmation message sent by the user terminal based on the binding page is received.

The card binding confirmation message is sent by the user terminal in response to a user input to the card binding page, and is used to indicate identity information about the target user.

Under a condition that the user information acquired by the card binding server from the back-end server of the first application does not include the identity information about the target user, the user terminal may acquire the identity information about the target user through the user input to the card binding page of the user terminal, and send the identity information about the target user to the card binding server through the card binding confirmation message.

Under a condition that the user information acquired by the card binding server from the back-end server of the first application includes the identity information about the target user, the card binding page may include the identity information, and correspondingly, the card binding confirmation message may include identity confirmation information characterizing that the identity information included in the card binding page is correct.

In step S205, the identity information is used to interact with a card issuing server and a back-end server of a card binding application, so as to complete a binding between a card identifier of the target card and a user identifier of the target user in the card binding application.

The card binding server may interact with the card issuing server to perform a verification on the target card and the identity information about the target user. The card binding server may interact with the back-end server of the card binding application to provide the card identifier of the target card to the back-end server of the card binding application, so as to achieve the binding between the card identifier of the target card and the user identifier of the target user in the card binding application. The card binding application includes the first application.

The card identifier of the target card may be assigned by the card binding server. In some examples, the card identifier may include a card number and/or a card payment identifier Token. Under a condition that the card identifier includes the card payment identifier Token, different applications corresponding to the same card may have different card payment identifiers Token. The card payment identifier Token is an alternative value of the card number of the card, and may consist of 13 to 19 digits, which is not limited herein. The card payment identifier Token can be used to bind the card, so that the security of card binding can be further improved.

In the embodiments of the present application, the card binding server accepts the access from the user terminal to the first page address indicated by the user terminal calling the first application to scan the information carrier pattern, and acquires the card number of the target card indicated by the information carrier pattern. The first page address is provided uniformly by the card binding server. The card binding server acquires the user information about the target user from the back-end server of the first application, and the target user is a user logging onto the first application. The access from the user terminal to the first page address triggers the card binding server to send, to the user terminal, the second page address corresponding to the redirected card binding page, so that the user terminal accesses the second page address and displays the card binding page. The card binding server may determine, through the card binding confirmation message that is sent by the user terminal based on the card binding page, the identity information about the target user, so that the binding between the card identifier of the target card and the user identifier of the target user in the card binding application can be completed through the interaction with the card issuing server and with the back-end server of the card binding application. It is not necessary for the user to look for a guiding entry of the card binding function in the application, and the card can be bound by calling the first application to scan an information carrier pattern to jump to the card binding page, thereby reducing the time required for the user to bind the card and improving the efficiency of the user using the application to bind the card.

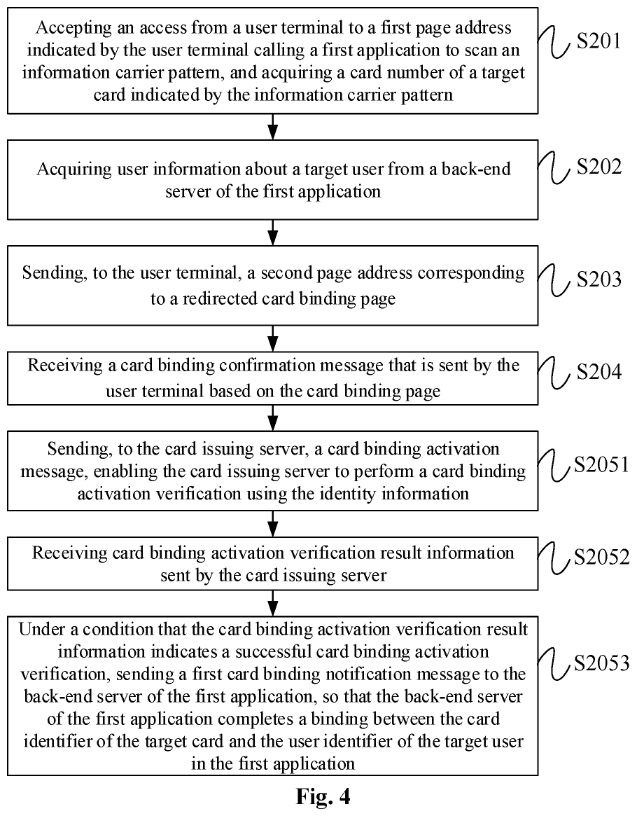

Specific processes for binding the card identifier of the target card with the user identifier of the target user in the first application are described below. FIG. 4 is a flowchart of another embodiment of the card binding method according to the first aspect of the present application. FIG. 4 differs from FIG. 2 in that step S205 in FIG. 2 may be specifically divided into steps S2051 to S2053 in FIG. 4.

In step S2051, a card binding activation message is sent to the card issuing server, enabling the card issuing server to perform a card binding activation verification using the identity information.

The card binding activation message may include the card number of the target card and the identity information. The card binding activation verification is a verification of whether the card number of the target card matches the identity information about the target user. The card issuing server stores a corresponding relationship between a card number of a card and identity information about a cardholder of the card. Under a condition that the identity information about the target user coincides with the identity information about a cardholder of the target card stored in the card issuing server, the target user is determined as the cardholder of the target card, that is, it is determined that the card number of the target card matches the identity information about the target user, and the card binding activation verification is successful. Under a condition that the identity information about the target user does not coincide with the identity information about the cardholder of the target card stored in the card issuing server, the target user is not the cardholder of the target card, that is, it is determined that the card number of the target card does not match the identity information about the target user, and the card binding activation verification fails. It may be determined through the card binding activation verification whether the target user is the cardholder of the target card, so as to ensure the security of card binding.

In step S2052, card binding activation verification result information sent by the card issuing server is received.

The card binding activation verification result information is used to indicate whether the card binding activation verification is successful.

In step S2053, under a condition that the card binding activation verification result information indicates a successful card binding activation verification, a first card binding notification message is sent to the back-end server of the first application, so that the back-end server of the first application completes a binding between the card identifier of the target card and the user identifier of the target user in the first application.

The first card binding notification message may include the card binding activation verification result information and the card identifier of the target card. Under a condition that the card binding activation verification is successful, the card binding server allows the back-end server of the first application to bind the target card, that is, the binding between the card identifier of the target card and the user identifier of the target user in the first application is allowed.

Under a condition that the card binding activation verification result information indicates an unsuccessful card binding activation verification, the card binding server may send, to the back-end server of the first application, a card binding failure notification message that may include the card binding activation verification result information. Under a condition that the card binding activation verification result information indicates an unsuccessful card binding activation verification, the card binding server does not send the card identifier of the target card to the back-end server of the first application, that is, the back-end server of the first application is not allowed to bind the target card.

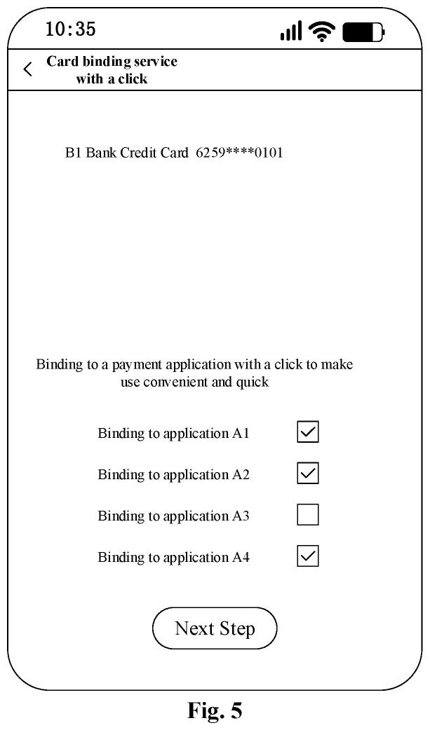

In some examples, the card binding page may further include one or more options of applications supported by the card binding server. Correspondingly, the card binding confirmation message may be further used to indicate a selected card binding application. The options of the applications supported by the card binding server can be ticked by a user to select an application required for card binding. For example, FIG. 5 is a schematic view of another example of a card binding page displayed on a user terminal according to an embodiment of the present application. As shown in FIG. 5, the card binding page may include the card number of the target card and options of applications, and the card number of the target card is 6259****0101, and the options of the applications include four options that can be ticked by a user: “binding to A1 application”, “binding to A2 application”, “binding to A3 application”, and “binding to A4 application”.

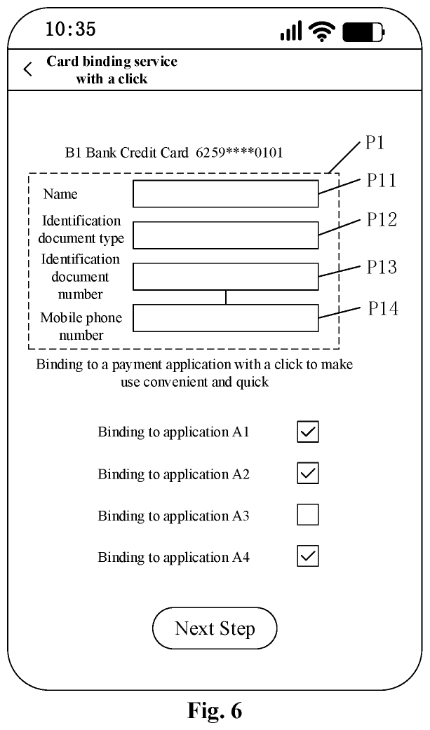

In some other examples, the card binding page may further include an area for filling in identity information, which needs a user to fill in identity information manually, so that the identity information can be used subsequently to verify the identity of the target user. For example, FIG. 6 is a schematic view of another example of a card binding page displayed on a user terminal according to an embodiment of the present application. In FIG. 6, as compared with FIG. 5, an area P1 for filling in identity information is added to the card binding page. As shown in FIG. 6, the area for filling in identity information may include a section P11 for filling in a real name, a section P12 for filling in a type of identification document, a section P13 for filling in an identification document number, and a section P14 for filling in a mobile phone number.

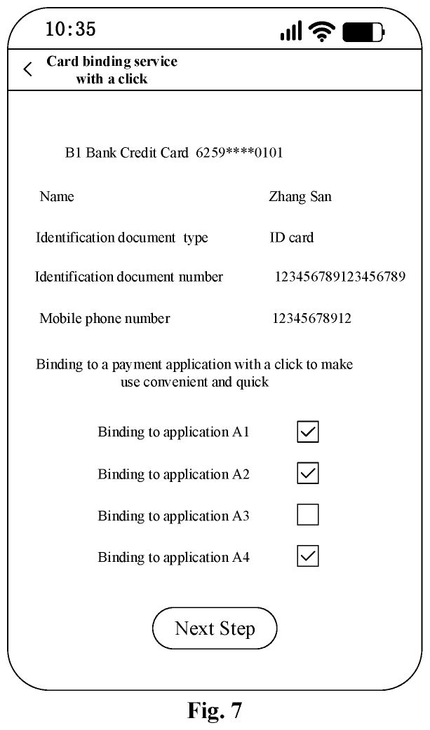

In some other examples, under a condition that the user information further includes identity information, the card binding page may further include the identity information. For example, FIG. 7 is a schematic view of another example of a card binding page displayed on a user terminal according to an embodiment of the present application. In FIG. 7, as compared with FIG. 5, the identity information is added to the card binding page, and the identity information includes a name, an identification document type, an identification document number, and a mobile phone number.

The card binding page may further include the identity information, and thus a user does not need to input the identity information manually, so as to avoid a potential error that may occur when the identity information is input manually, on the basis that the identity verification of the target user can be performed using the identity information. User operations in the card binding process can be reduced, and thereby the success rate of the card binding can be improved and the card binding process can be simplified.

In the embodiments, the card binding confirmation message may include an identifier of the card binding application, or other information that can characterize the card binding application, which is not limited herein.

Under a condition that the card binding page further includes one or more options of applications supported by the card binding server, and the card binding confirmation message is further used to indicate a selected card binding application, the card binding application may include an application selected by the user from the one or more options of applications supported by the card binding server. Specifically, the card binding application may include a first application and a second application. The second application is different from the first application, that is, the second application includes at least one application other than the first application among the applications supported by the card binding server. The second application may include one or more applications, and the number of second applications is not limited herein. For example, under a condition that the card binding page after the user operation is such as shown in FIG. 7 and the first application is the application A1, the second application includes the application A2 and the application A4.

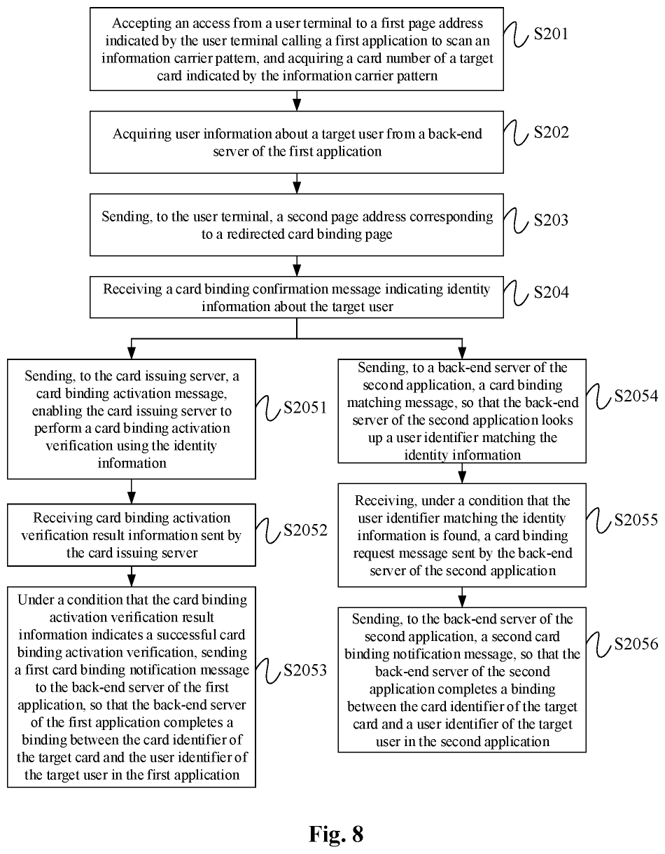

Specific processes for binding the card identifier of the target card with the user identifier of the target user in the second application are described below. FIG. 8 is a flowchart of another embodiment of the card binding method according to the first aspect of the present application. FIG. 8 differs from FIG. 4 in that step S205 in FIG. 2 may be further specifically divided into steps S2054 to S2056 in FIG. 8.

In step S2054, a card binding matching message is sent to a back-end server of the second application, so that the back-end server of the second application looks up a user identifier matching the identity information.

The card binding matching message may include the identity information. The back-end server of the second application stores a corresponding relationship between the user identifier and the identity information about the user in the second application. The back-end server of the second application acquires the identity information about the target user from the card binding matching message, uses the identity information in the card binding matching message to match the user identity information stored in the back-end server of the second application, and determines a user identifier corresponding to identity information coincided with the identity information in the card binding matching message as the user identifier matching the identity information in the card binding matching message.

In step S2055, under a condition that the user identifier matching the identity information is found, a card binding request message sent by the back-end server of the second application is received.

If the back-end server of the second application finds the user identifier matching the identity information, it means that the target user has been registered in the second application, that is, the target user is included in registered users of the second application. The back-end server of the second application may send, to the card binding server, a card binding request message to request the card identifier of the target card.

If the back-end server of the second application does not find the user identifier matching the identity information, it means that the target user has not been registered in the second application, that is, the target user is not included in the registered users of the second application, and thus the target card cannot be bound in the second application.

In some examples, the card binding matching message may have an effective duration. The card binding matching message is valid in the effective duration. The card binding matching message fails beyond the effective duration. That is, under a condition that the card binding server does not receive the card binding request message sent by the back-end server of the second application in the effective duration, the card binding process ends for the second application.

In step S2056, a second card binding notification message is sent to the back-end server of the second application, so that the back-end server of the second application completes a binding between the card identifier of the target card and a user identifier of the target user in the second application.

The second card binding notification message may include the card identifier of the target card. The user identifier of the target user in the second application is a user identifier matching the identity information. The back-end server of the second application receives the second card binding notification message, and can complete the binding between the card identifier of the target card and the user identifier of the target user in the second application.

In some examples, before the card binding request message sent by the back-end server of the second application is received in step S2055, the back-end server of the second application may push a request confirmation message to a user corresponding to the found user identifier matching the identity information. The request confirmation message is used to prompt the user to determine whether to bind the card, and the form of the request confirmation message is not limited herein. Under a condition that the back-end server of the second application receives a message to determine the card binding fed back by the user through the user terminal, the card binding request message is sent to the card binding server. That is, under a condition that the user identifier matching the identity information is found and the back-end server of the second application receives the message to determine the card binding fed back by the user through the user terminal, the card binding server receives the card binding request message sent by the back-end server of the second application. The security of the card binding may be further ensured through a re-confirmation by the user.

Under a condition that the card binding application includes a plurality of second applications, the card binding server may perform the steps S2054 to S2056 for a back-end server of each second application.

Steps S2051 to S2053 and steps S2054 to S2056 may be executed in sequence, or steps S2051 to S2053 and steps S2054 to S2056 may be executed synchronously, and the execution timing of steps S2051 to S2053 and steps S2054 to S2056 is not limited in the embodiments of the present application.

The card binding application includes the first application and the second application(s). The interaction with the card issuing server and the back-end server of the card binding application can be performed by using the identity information, so as to complete the binding between the card identifier of the target card and the user identifier of the target user in the card binding application. In this way, card binding operations for a plurality of applications may be initiated at the same time, and it is not necessary to enter respective applications one by one to initiate the card binding operation, thereby simplifying a card binding process in a multi-application card binding scenario. Moreover, initiating the card binding operations for the plurality of applications at the same time enhances an interconnectivity among the plurality of applications in which the same card has been bound, thereby facilitating management by the user.

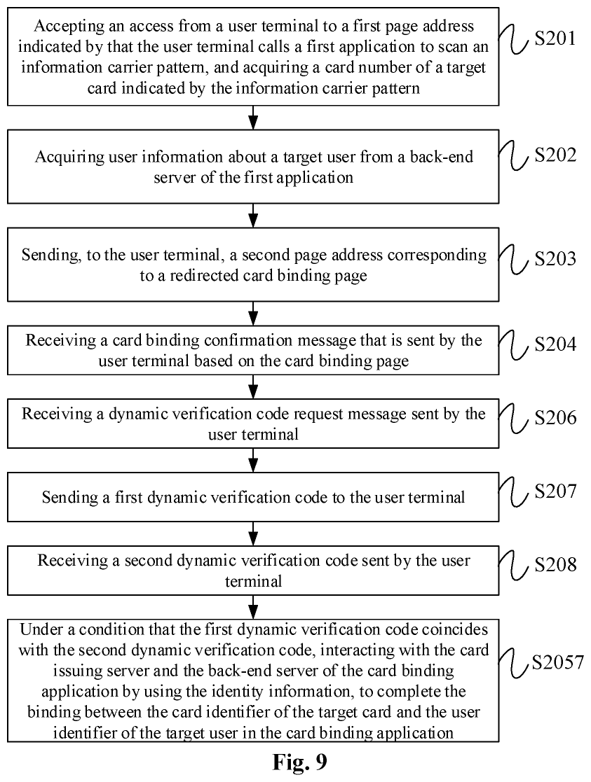

In some embodiments, in order to further ensure the security of the card binding, a further security verification may be performed between the card binding server and the user terminal through a dynamic verification code. FIG. 9 is a flowchart of another embodiment of the card binding method according to the first aspect of the present application. FIG. 9 differs from FIG. 2 in that the card binding method shown in FIG. 9 may further include steps S206 to S208, and step S205 in FIG. 2 may be specified as step S2057 in FIG. 9.

In step S206, a dynamic verification code request message sent by the user terminal is received.

In some examples, the user terminal may send, in response to a user input, the dynamic verification code request message to the card binding server. The dynamic verification code request message is used to request a dynamic verification code from the card binding server.

In step S207, a first dynamic verification code is sent to the user terminal.

The first dynamic verification code is a dynamic verification code sent by the card binding server to the user terminal. For example, the card binding server may acquire a mobile phone number of the target user from the identity information about the target user, and send the first dynamic verification code to the user terminal of the target user through a short message.

In step S208, a second dynamic verification code sent by the user terminal is received.

The second dynamic verification code is a dynamic verification code that is received by the user terminal and input by the user. The first dynamic verification code may or may not be the same as the second dynamic verification code.

In step S2057, under a condition that the first dynamic verification code coincides with the second dynamic verification code, an interaction with the card issuing server and the back-end server of the card binding application is performed by using the identity information, to complete the binding between the card identifier of the target card and the user identifier of the target user in the card binding application.

The card binding server performs a verification using the first dynamic verification code and the second dynamic verification code. Under a condition that the first dynamic verification code coincides with the second dynamic verification code, it means that the dynamic verification code verification is successful, and the binding between the card identifier of the target card and the user identifier of the target user in the card binding application can be performed. Under a condition that the first dynamic verification code does not coincide with the second dynamic verification code, the card binding process suspends.

Only when the dynamic verification code verification is successful, the card binding process continues, so as to avoid card binding by an illegal user, thereby further improving the security of card binding.

In some embodiments, after the binding between the card identifier of the target card and the user identifier of the target user in the card binding application is completed, the card binding server may send a third page address corresponding to a redirected card binding result page to the user terminal. The card binding server may accept the access from the user terminal to the third page address.

The card binding result page is used to characterize that the binding between the card identifier of the target card and the user identifier of the target user in the card binding application has been completed. The user terminal accesses the third page address and displays the card binding result page, and the user is thereby prompted of successful card binding.

In some embodiments, under a condition that the binding between the card identifier of the target card and the user identifier of the target user in the card binding application is not allowed, that is, the card binding fails, the card binding server may send a page address corresponding to a redirected card binding failure prompt page to the user terminal, so as to display the card binding failure prompt page to the user prompt by the user terminal, to prompt the user that the card binding fails.

In some embodiments, the card binding server may further provide, to the user terminal, a card binding management page, which can be used by the user to manage a binding relationship of the target card. Specifically, the card binding server may accept an access from the user terminal to a fourth page address corresponding to the card binding management page. The card binding management page may include a binding relationship between the card identifier of the target card and the user identifier of the target user in the card binding application. The card binding server may receive a management operation instruction of the user terminal and perform a management operation on a binding relationship indicated by the management operation instruction.

The management operation may include one or more of a disabling operation, an enabling operation, and a payment limit setting operation. The management operation may further include another type of operation, which is not limited herein.

The disabling operation is an operation for disabling a binding relationship between the card identifier of the target card and a user identifier of the target user in each of one or more certain card binding applications. The disabling operation is performed on a certain binding relationship, that is, payment with the target card is disabled in application(s) corresponding to the binding relationship.

The enabling operation is an operation for enabling a binding relationship between the card identifier of the target card and a user identifier of the target user in each of one or more certain card binding applications. The enabling operation is performed on a certain binding relationship, that is, payment by the target card is enabled in application(s) corresponding to the binding relationship.

The payment limit setting operation is an operation for setting a limit on payment for a binding relationship between the card identifier of the target card and a user identifier of the target user in one or more certain card binding applications. The payment limit setting operation is performed on a certain binding relationship, that is, a payment limit on the target card is set in application(s) corresponding to the binding relationship.

It should be noted that, the first page address, the second page address, the third page address, and the fourth page address in the above embodiments may include Uniform Resource Locator (URL) addresses, which is not limited herein.

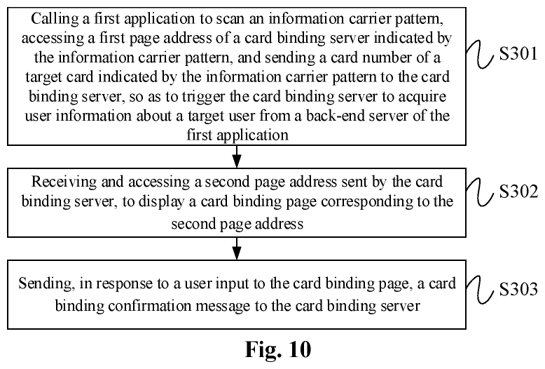

A second aspect of the present application provides a card binding method applicable to a user terminal, that is, the card binding method may be executed by the user terminal. FIG. 10 is a flowchart of an embodiment of a card binding method according to a second aspect of the present application. As shown in FIG. 10, the card binding method may include steps S301 to S303.

In step S301, a first application is called to scan an information carrier pattern, a first page address of a card binding server indicated by the information carrier pattern is accesses and a card number of a target card indicated by the information carrier pattern is sent to the card binding server, so as to trigger the card binding server to acquire user information about a target user from a back-end server of the first application.

The user terminal may call the first application to scan the information carrier pattern, so as to jump to a browser to access the first page address of the card binding server. Access of the first page address by the user terminal may trigger the card binding server to acquire the user information about the target user from the back-end server of the first application. The target user is a user logging onto the first application. The user information includes a user identifier of the target user in the first application.

The user terminal may send an unencrypted card number of the target card to the card binding server. Alternatively, the user terminal may send an encrypted card number of the target card to the card binding server, that is, the user terminal may send, to the card binding server, the card number of the target card encrypted with a first key. The card binding server may store a second key paired with the first key, and may decrypt the encrypted card number of the target card using the second key. In some examples, the user terminal may acquire the encrypted card number of the target card. In some other examples, the user terminal may acquire a unencrypted card number of the target card, and encrypt the card number of the target card using the first key to acquire the encrypted card number of the target card.

In some examples, the information carrier pattern may include a Quick Response (QR) code. Information recorded by the QR code may include the first page address and the card number of the target card.

In some other examples, the information carrier pattern may include the QR code. The information recorded by the QR code may include the first page address and an encrypted version of the card number of the target card.

In some other examples, the information carrier pattern may include a surface pattern of the target card. The surface pattern may include a page jump mark and the card number of the target card. The page jump mark corresponds to the first page address.

In step S302, a second page address sent by the card binding server is received and accessed, to display a card binding page corresponding to the second page address.

The card binding page may include at least a part of the card number of the target card.

In some examples, the card binding page may further include one or more options of applications supported by the card binding server.

In some other examples, the card binding page may further include an area for filling in the identity information.

In some other examples, the user information may further include the identity information, and correspondingly, the card binding page may further include the identity information.

In step S303, a card binding confirmation message is sent, in response to a user input to the card binding page, to the card binding server, enabling the card binding server to interact with a card issuing server and a back-end server of a card binding application by using the identity information, to complete a binding between a card identifier of the target card and a user identifier of the target user in the card binding application.

The card binding confirmation message may indicate identity information about the target user. The card binding application may include the first application.

In some examples, under a condition that the card binding page further includes one or more options of applications supported by the card binding server, the card binding confirmation message may be further used to indicate a selected card binding application, and the card binding application may further include a second application that is different from the first application.

The user input to the card binding page may be related to the content of the card binding page. For example, the card binding page may include at least a part of the card number of the target card, or at least a part of the card number of the target card and the identity information, and the user input to the card binding page may include a confirmation input to the application. As another example, the card binding page may include at least a part of the card number of the target card and an area for filling in the identity information, and the user input to the card binding page may include a confirmation input and a filling input to the area for filling in the identity information. As another example, the card binding page may include at least a part of the card number of the target card, one or more options of applications supported by the card binding server, and the area for filling in the identity information, and the user input to the card binding page may include a confirmation input, a selection input to select an application, and a filling input to the area for filling in the identity information.

In some examples, the card identifier may include a card number and/or a card payment identifier Token.

For specific contents of steps S301 to S303, reference may be made to the relevant description in the above embodiments, which will not be repeated here.

In the embodiments of the present application, the user terminal calls the first application to scan the information carrier pattern, to trigger the access to the first page address of the card binding server indicated by the information carrier pattern, and to send the card number of the target card indicated by the information carrier pattern to the card binding server, so as to trigger the card binding server to acquire the user information about the target user (who is a user logging onto the first application) from the back-end server of the first application. The user terminal receives and accesses the second page address corresponding to the card binding page, and displays the card binding page. The user terminal sends, to the card binding server through the card binding confirmation message, identity information confirmed by the user and a selected card binding application, so that the card binding server can complete the binding between the card identifier of the target card and the user identifier of the target user in the card binding application through the interaction with the card issuing server and the back-end server of the card binding application. It is not necessary for the user to look for a guiding entry of the card binding function in the application, and the card can be bound directly by using a scanning function of the user terminal to jump to the card binding page, thereby reducing the time required for the user to bind the card and improving the efficiency of the user using the application to bind the card.

Under a condition that the card binding includes the first application and the second application, the user terminal can send, to the card binding server through the card binding confirmation message, the identity information confirmed by the user and the selected card binding application, so that the card binding server can complete the binding between the card identifier of the target card and the user identifier of the target user in the card binding application through the interaction with the card issuing server and the back-end server of the card binding application. Card binding operations for a plurality of applications may be initiated at the same time, and it is not necessary to enter respective applications one by one to initiate the card binding operation, thereby simplifying a card binding process in a multi-application card binding scenario. Moreover, initiating the card binding operations for the plurality of applications at the same time enhances an interconnectivity among the plurality of applications in which the same card has been bound, thereby facilitating management by the user.

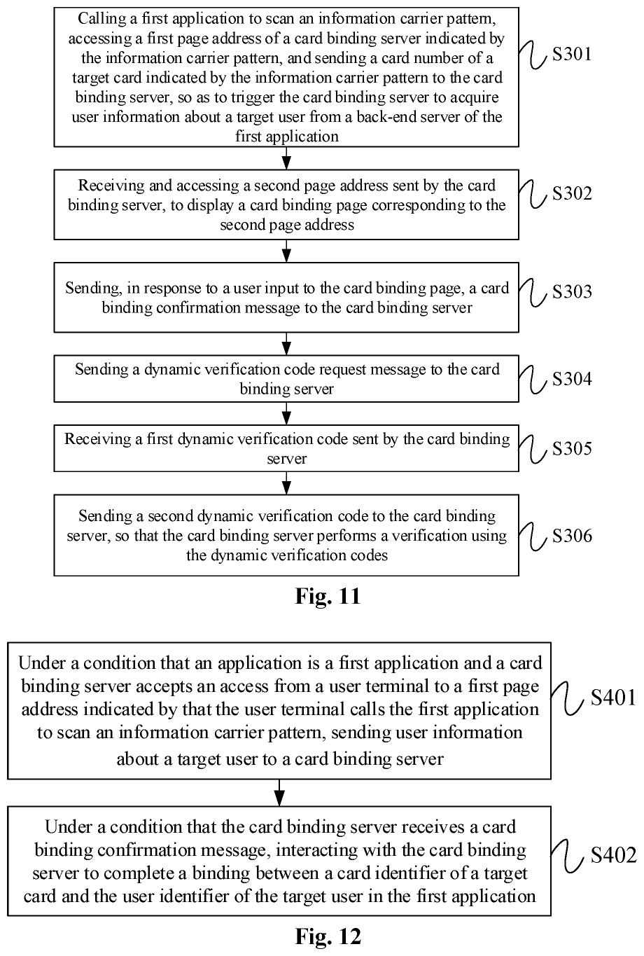

In some embodiments, in order to further ensure the security of the card binding, a further security verification may be performed between the user terminal and the card binding server through a dynamic verification code. FIG. 11 is a flowchart of another embodiment of the card binding method according to the second aspect of the present application. FIG. 11 is different from FIG. 10 in that the card binding method shown in FIG. 11 further includes steps S304 to S306.

In step S304, a dynamic verification code request message is sent to the card binding server.

In step S305, a first dynamic verification code sent by the card binding server is received.

In step S306, a second dynamic verification code is sent to the card binding server, so that the card binding server performs a verification using the first dynamic verification code and the second dynamic verification code.

It should be noted that, under a condition that the card binding method includes steps S304 to S306, only when the dynamic verification code verification performed by the card binding server is successful, the card binding server interacts with the card issuing server and the back-end server of the card binding application using the identity information, to complete the binding between the card identifier of the target card and the user identifier of the target user in the card binding application.

For specific contents of steps S304 to S306, reference may be made to the relevant content in the above embodiments, which will not be repeated here.

In some embodiments, after the binding between the card identifier of the target card and the user identifier of the target user in the card binding application is completed, the user terminal receives and accesses a third page address sent by the card binding server and corresponding to a card binding result page to display the card binding result page. The card binding result page is used to characterize that the binding between the card identifier of the target card and the user identifier of the target user in the card binding application has been completed.

In some embodiments, under a condition that the binding between the card identifier of the target card and the user identifier of the target user in the card binding application is not allowed, that is, the card binding fails, the user terminal may receive and access the page address corresponding to the redirected card binding failure prompt page sent by the card binding server, display the card binding failure prompt page, and prompt the user that the card binding fails.

In some embodiments, the card binding server may further provide, to the user terminal, a card binding management page that can be used by the user to manage a binding relationship of the target card. The user terminal may access a fourth page address of the card binding server to display a card binding management page corresponding to the fourth page address. The card binding management page includes a binding relationship between the card identifier of the target card and the user identifier of the target user in the card binding application. The user terminal may send, in response to a user input, a management operation instruction to the card binding server, wherein the management operation instruction instructs the card binding server to perform a management operation on the binding relationship.

The management operation may include one or more of a disabling operation, an enabling operation, and a payment limit setting operation.

For specific contents of the fourth page address, the card binding management page, the binding relationship, the management operation, and the like, reference may be made to the relevant description in the above embodiments, which will not be repeated here.

A third aspect of the present application provides a card binding method applicable to a back-end server of an application, that is, the card binding method can be executed by the back-end server of the application. The back-end server corresponds to a first application, that is, the back-end server is the back-end server of the first application. FIG. 12 is a flowchart of an embodiment of the card binding method according to the third aspect of the present application. As shown in FIG. 12, the card binding method may include steps S401 and S402.

In step S401, under a condition that an application is the first application and a card binding server accepts an access from a user terminal to a first page address indicated by the user terminal calling the first application to scan an information carrier pattern, user information about a target user is sent to a card binding server.

The target user is a user logging onto the first application. The user information includes a user identifier of the target user in the first application.

In some examples, the information carrier pattern may include a Quick Response (QR) code. The information recorded by the QR code may include the first page address and the card number of the target card.

In some other examples, the information carrier pattern may include the QR code. The information recorded by the QR code may include the first page address and an encrypted version of the card number of the target card.

In some other examples, the information carrier pattern may include a surface pattern of the target card. The surface pattern may include a page jump mark and the card number of the target card. The page jump mark corresponds to the first page address.

In step S402, when receiving a card binding confirmation message, the card binding server interacts with the card binding server to complete a binding between a card identifier of a target card and the user identifier of the target user in the first application.

The card binding confirmation message is sent by the user terminal in response to a user input to a card binding page, and is used to indicate identity information about the target user. The card binding page includes at least a part of the card number of the target card. The card binding application includes the first application.

In some examples, the card binding page may further include an area for filling in the identity information.

In some other examples, the user information may further include the identity information, and the card binding page may further include the identity information.

In some examples, the card identifier may include a card number and/or a card payment identifier Token.

For specific contents of steps S401 and S402, reference may be made to the relevant description in the above embodiments, which will not be repeated here.

In the embodiment of the present application, under a condition that the card binding server accepts the access from the user terminal to the first page address indicated by the user terminal calling the first application to scan the information carrier pattern, the card binding server, as the back-end server of the first application, may send the user information about the target user to the card binding server. The user terminal receives and accesses the second page address corresponding to the card binding page, and displays the card binding page. The user terminal sends, to the card binding server through the card binding confirmation message, the identity information confirmed by the user and the selected card binding application, and may interact, as the back-end server of the first application, with the card binding server to complete the binding between the card identifier of the target card and the user identifier of the target user in the first application. It is not necessary for the user to look for a guiding entry of the card binding function in the application, and the card can be bound by calling the first application to scan an information carrier pattern to jump to the card binding page, thereby reducing the time required for the user to bind the card and improving the efficiency of the user using the application to bind the card.

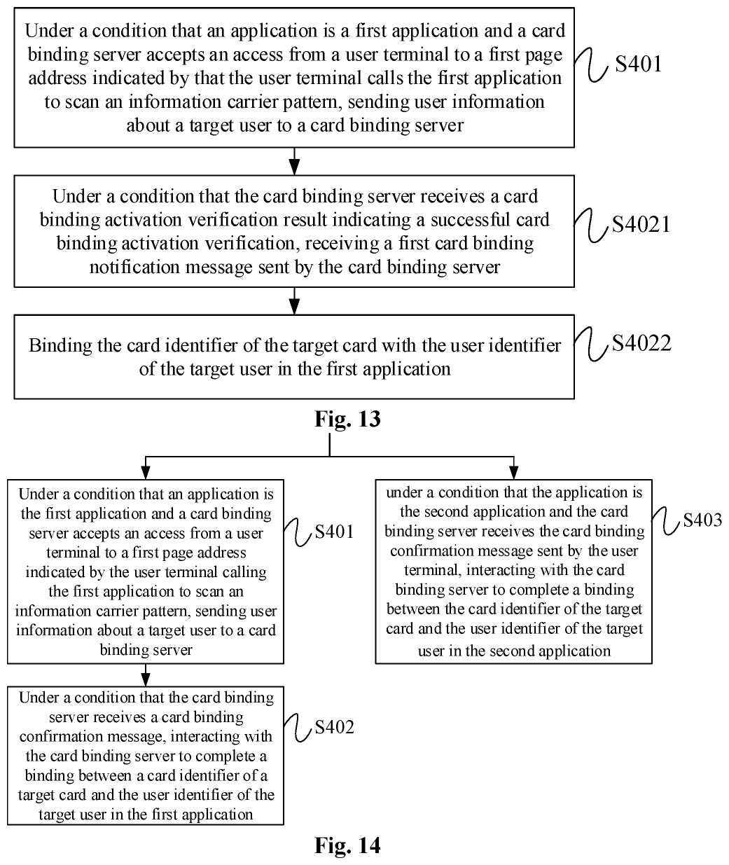

The specific process in which the back-end server interacts with the card binding server under a condition that the application is the first application is described below: FIG. 13 is a flowchart of another embodiment of the card binding method according to the third aspect of the present application. FIG. 13 differs from FIG. 12 in that step S402 in FIG. 12 may be specifically divided into steps S4021 and S4022 in FIG. 13.

In step S4021, a first card binding notification message sent by the card binding server is received, under a condition that the card binding server receives a card binding activation verification result indicating a successful card binding activation verification.

The first card binding notification message includes card binding activation verification result information and the card identifier of the target card.

In step S4022, the card identifier of the target card is bound with the user identifier of the target user in the first application.

For specific contents of steps S4021 and S4022, reference may be made to the relevant description in the above embodiments, which will not be repeated here.

In some embodiments, the card binding page may further include one or more options of applications supported by the card binding server, and the card binding confirmation message may be used to indicate a selected card binding application, which may further include a second application. The first application is different from the second application. FIG. 14 is a flowchart of another embodiment of the card binding method according to the third aspect of the present application. FIG. 14 differs from FIG. 12 in that FIG. 14 may further include step S403.

In step S403, under a condition that the application is the second application and the card binding server receives the card binding confirmation message sent by the user terminal, an interaction with the card binding server is performed to complete a binding between the card identifier of the target card and the user identifier of the target user in the second application.

Under a condition that the application corresponding to the back-end server is the first application, the back-end server may interact with the card binding server to complete the binding between the card identifier of the target card and the user identifier of the target user in the first application. Under a condition that the application corresponding to the back-end server is the second application, the back-end server may interact with the card binding server to complete the binding between the card identifier of the target card and the user identifier of the target user in the second application. The back-end server of the application may cooperate with the user terminal and the card binding server, so that card binding operations for a plurality of applications may be initiated at the same time, and it is not necessary to enter respective applications one by one to initiate the card binding operation, thereby simplifying a card binding process in a multi-application card binding scenario. Moreover, initiating the card binding operations for the plurality of applications at the same time enhances an interconnectivity among the plurality of applications in which the same card has been bound, thereby facilitating management by the user.

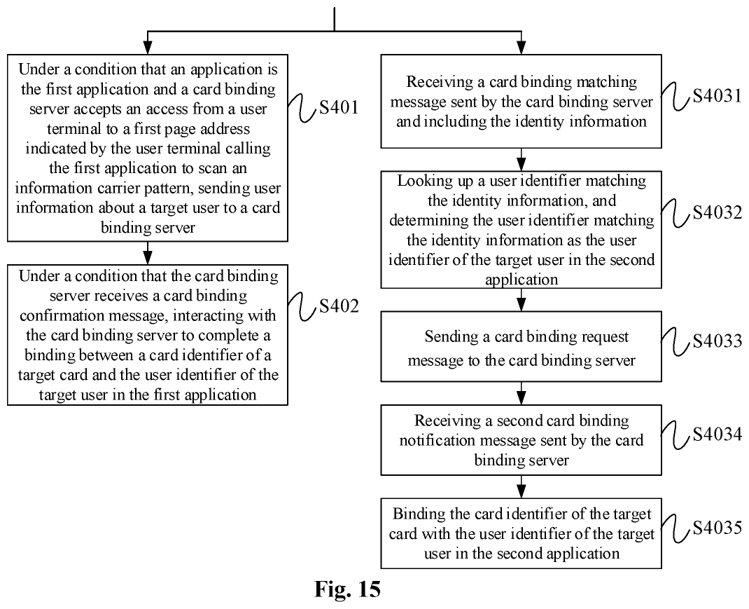

The specific process in which the back-end server interacts with the card binding server under a condition that the application is the second application is described below: FIG. 15 is a flowchart of another embodiment of the card binding method according to the third aspect of the present application. FIG. 15 differs from FIG. 14 in that step S403 in FIG. 14 may be specifically divided into steps S4031 to S4035 in FIG. 15.

In step S4031, a card binding matching message sent by the card binding server is received, which includes the identity information.

In step S4032, a user identifier matching the identity information is looked up, and the user identifier matching the identity information is determined as the user identifier of the target user in the second application.

In step S4033, a card binding request message is sent to the card binding server.

The card binding request message is used to request the card identifier of the target card.

In step S4034, a second card binding notification message sent by the card binding server is received.

The second card binding notification message includes the card identifier of the target card.

In step S4035, the card identifier of the target card is bound with the user identifier of the target user in the second application.

For specific contents of steps S4031 to S4035, reference may be made to the relevant description in the above embodiments, which will not be repeated here.

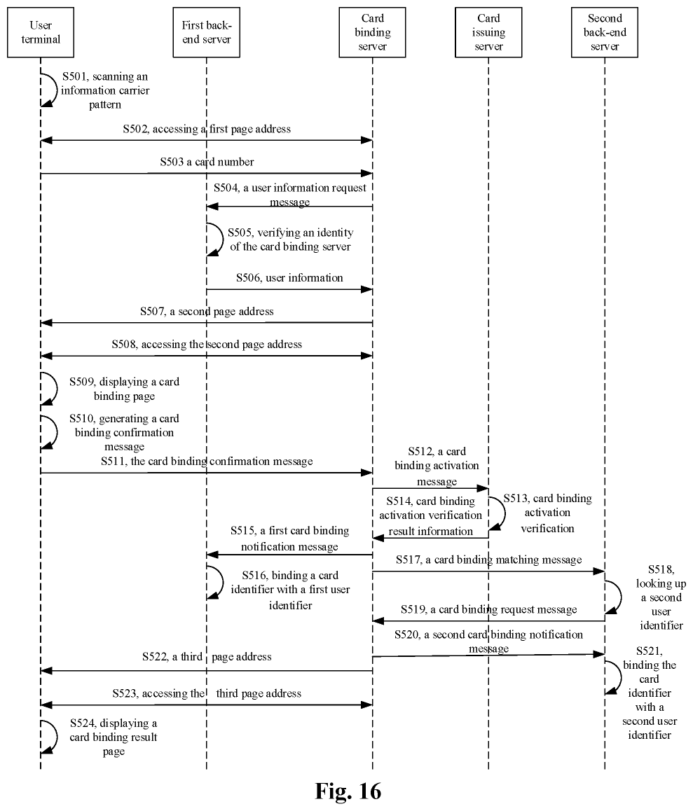

To facilitate understanding, an example will be described below to illustrate the overall process of the card binding methods in the above embodiments as. FIG. 16 is a flowchart of an example of a card binding process according to an embodiment of the present application. In the example, a first back-end server is a back-end server of a first application, and a second back-end server is a back-end server of a second application. As shown in FIG. 16, the card binding process may include steps S501 to S524.

In step S501, a user terminal calls the first application to scan an information carrier pattern.

In step S502, the user terminal accesses a first page address of a card binding server indicated by the scanned information carrier pattern.

In step S503, the user terminal sends a card number indicated by the information carrier pattern to the card binding server.

In step S504, the card binding server sends a user information request message to the first back-end server, and requests, from the first back-end server, user information about a target user logging onto the first application.

In step S505, the first back-end server verifies an identity of the card binding server.

In step S506, under a condition that the identity verification of the card binding server is successful, the first back-end server feeds back the user information about the target user to the card binding server.

The user information includes the user identifier of the target user in the first application and the identity information about the target user. For ease of illustration, the user identifier of the target user in the first application is referred to as a first user identifier.

In step S507, the card binding server sends a redirected second page address to the user terminal.

The second page address is an address of a card binding page.

In step S508, the user terminal accesses the second page address.

In step S509, the user terminal displays the card binding page.

In step S510, the user terminal receives a user input to the card binding page and generates a card binding confirmation message.

In step S511, the user terminal sends the card binding confirmation message to the card binding server.

The card binding confirmation message is used to indicate the identity information about the target user and selected card binding application(s). The card binding application(s) may include the first application and the second application. For ease of illustration, the back-end server of the second application is referred to as the second back-end server here.

In step S512, the card binding server sends a card binding activation message to a card issuing server.

In step S513, the card issuing server acquires the card number and the identity information about the target user from the card binding activation message, and performs a card binding activation verification using the card number and the identity information about the target user to obtain card binding activation verification result information.

In step S514, the card issuing server sends the card binding activation verification result information to the card binding server.

In step S515, under a condition that the card binding activation verification result information indicates a successful card binding activation verification, the card binding server sends a first card binding notification message to the first back-end server.

The first card binding notification message includes a card identifier.

In step S516, the first back-end server binds the card identifier with the first user identifier.

In step S517, the card binding server sends a card binding matching message to the second back-end server.

The card binding matching message includes the identity information about the target user.

In step S518, the second back-end server looks up a user identifier matching the identity information, and determines the user identifier matching the identity information as the user identifier of the target user in the second application.

For ease of illustration, the user identifier of the target user in the second application is referred to as a second user identifier here.

In step S519, the second back-end server sends the card binding request message to the card binding server to request the card identifier.

In step S520, the card binding server sends the second card binding notification message to the second back-end server.

The second card binding notification message includes a card identifier.

In step S521, the second back-end server binds the card identifier with the second user identifier.

In step S522, the card binding server sends a third page address to the user terminal.

The third page address is a card binding result page.

In step S523, the user terminal accesses the third page address.

In step S524, the user terminal displays the card binding result page.

For specific contents of above steps S501 to S524, reference may be made to the relevant description in the above embodiments, which will not be repeated here.

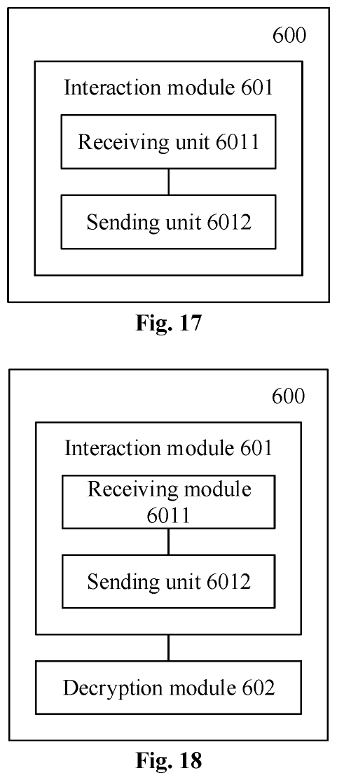

A fourth aspect of the present application provides a server, i.e., the card binding server in the above embodiments. FIG. 17 is a schematic structural view of an embodiment of the server according to the fourth aspect of the present application. As shown in FIG. 17, the server 600 may include an interaction module 601 that may include a receiving unit 6011 and a sending unit 6012.

The interaction module 601 may be configured to accept an access from a user terminal to a first page address indicated by the user terminal calling a first application to scan an information carrier pattern and acquire a card number of a target card indicated by the information carrier pattern, and configured to acquire user information about a target user from a back-end server of the first application.

The target user is a user logging onto the first application. The user information includes a user identifier of the target user in the first application.

In some examples, the information carrier pattern may include a QR code, and information recorded in the QR code may include the first page address and the card number of the target card.

In some other examples, the information carrier pattern may include a QR code, and information recorded in the QR code may include the first page address and an encrypted version of the card number of the target card

In some other examples, the information carrier pattern may include a surface pattern of the target card, the surface pattern may include a page jump mark and the card number of the target card, and the page jump mark corresponds to the first page address.

The sending unit 6012 is configured to send, to the user terminal, a second page address corresponding to a redirected card binding page.

The card binding page may include at least a part of the card number of the target card.

In some examples, the card binding page may further include one or more options of applications supported by the card binding server.

In some other examples, the card binding page may further include an area for filling in the identity information.

In some other examples, the user information may further include the identity information, and the card binding page may further include the identity information.

The receiving unit 6011 may be further configured to receive a card binding confirmation message that is sent by the user terminal based on the card binding page.

The card binding confirmation message may be used to indicate identity information about the target user.

The interaction module 601 may be further configured to interact with a card issuing server and a back-end server of a card binding application using the identity information, to complete a binding between a card identifier of the target card and a user identifier of the target user in the card binding application.

The card binding application may include the first application.

In some examples, the card identifier may include a card number and/or a card payment identifier Token.

In the embodiments of the present application, the card binding server accepts the access from the user terminal to the first page address indicated by the user terminal calling the first application to scan the information carrier pattern, and acquires the card number of the target card indicated by the information carrier pattern. The first page address is provided uniformly by the card binding server. The card binding server acquires the user information about the target user from the back-end server of the first application, and the target user is a user logging onto the first application. The access from the user terminal to the first page address triggers the card binding server to send, to the user terminal, the second page address corresponding to the redirected card binding page, so that the user terminal accesses the second page address and displays the card binding page. The card binding server may determine, through the card binding confirmation message that is sent by the user terminal based on the card binding page, the identity information about the target user, so that the binding between the card identifier of the target card and the user identifier of the target user in the card binding application can be completed through the interaction with the card issuing server and with the back-end server of the card binding application. It is not necessary for the user to look for a guiding entry of the card binding function in the application, and the card can be bound by the first application to scan an information carrier pattern to jump to the card binding page, thereby reducing the time required for the user to bind the card and improving the efficiency of the user using the application to bind the card.

In some embodiments, the above sending unit 6012 may be configured to send, to the card issuing server, a card binding activation message, enabling the card issuing server to perform a card binding activation verification using the identity information.

The card binding activation message may include the card number of the target card and the identity information.

The receiving unit 6011 may be configured to receive card binding activation verification result information sent by the card issuing server.

The sending unit 6012 may be configured to send, under a condition that the card binding activation verification result information indicates a successful card binding activation verification, a first card binding notification message to the back-end server of the first application, so that the back-end server of the first application completes a binding between the card identifier of the target card and the user identifier of the target user in the first application.

The first card binding notification message may include the card binding activation verification result information and the card identifier of the target card.

In some embodiments, under a condition that the card binding page may further include one or more options of applications supported by the card binding server, the card binding confirmation message may be further used to indicate a selected card binding application, and the card binding application may further include a second application different from the first application.

The sending unit 6012 may be further configured to send, to a back-end server of the second application, a card binding matching message, so that the back-end server of the second application looks up a user identifier matching the identity information.

The card binding matching message may include the identity information.

The receiving unit 6011 may be configured to receive, under a condition that the user identifier matching the identity information is found, a card binding request message sent by the back-end server of the second application.

The card binding request message may be used to request the card identifier of the target card.

The sending unit 6012 may be configured to send, to the back-end server of the second application, a second card binding notification message, so that the back-end server of the second application completes a binding between the card identifier of the target card and a user identifier of the target user in the second application.

The second card binding notification message may include the card identifier of the target card. The user identifier of the target user in the second application is the user identifier matching the identity information.

FIG. 18 is a schematic structural view of another embodiment of the server according to the fourth aspect of the present application. FIG. 18 differs from FIG. 17 in that the server 600 shown in FIG. 18 may further include a decryption module 602.

The above receiving unit 6011 may be configured to receive the card number of the target card, sent by the user terminal and encrypted with a first key.

The decryption module 602 may be configured to decrypt the encrypted card number of the target card using a pre-stored second key paired with the first key, to obtain the card number of the target card.

In some embodiments, the receiving unit 6011 may be further configured to receive a dynamic verification code request message sent by the user terminal.

The above sending unit 6012 may be further configured to send a first dynamic verification code to the user terminal.

The above receiving unit 6011 may be further configured to receive a second dynamic verification code sent by the user terminal.

The above interaction module 601 may be further configured to interact, under a condition that the first dynamic verification code coincides with the second dynamic verification code, with the card issuing server and the back-end server of the card binding application by using the identity information, to complete the binding between the card identifier of the target card and the user identifier of the target user in the card binding application.

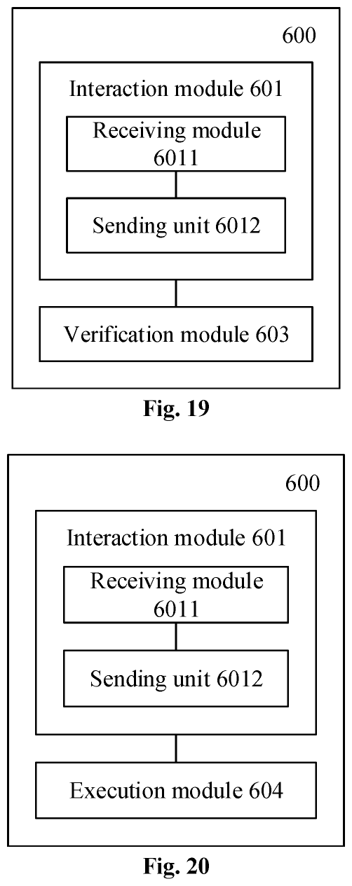

FIG. 19 is a schematic structural view of another embodiment of the server according to the fourth aspect of the present application. FIG. 19 differs from FIG. 17 in that the server 600 shown in FIG. 19 may further include a verification module 603.

The verification module 603 may be configured to determine whether the first application belongs to application(s) supported by the card binding server.

The above receiving unit 6011 may be configured to acquire, under a condition that the first application belongs to the application(s) supported by the card binding server, the user information about the target user from the back-end server of the first application.

In some embodiments, the above sending unit 6012 may be further configured to send a third page address corresponding to a redirected card binding result page to the user terminal.

The card binding result page may be used to characterize that the binding between the card identifier of the target card and the user identifier of the target user in the card binding application has been completed.

The above interaction module 601 may be configured to accept the access from the user terminal to the third page address.

FIG. 20 is a schematic structural view of another embodiment of the server according to the fourth aspect of the present application. FIG. 20 differs from FIG. 17 in that the server 600 shown in FIG. 20 may further include an execution module 604.

The above interaction module 601 may be further configured to accept an access from the user terminal to a fourth page address corresponding to a card binding management page.

The card binding management page includes a binding relationship between the card identifier of the target card and the user identifier of the target user in the card binding application.

The above receiving unit 6011 may be further configured to receive a management operation instruction of the user terminal.

The execution module 604 may be configured to perform, according to the management operation instruction, a management operation on a binding relationship indicated by the management operation instruction.

In some examples, the management operation may include one or more of a disabling operation, an enabling operation, and a payment limit setting operation.

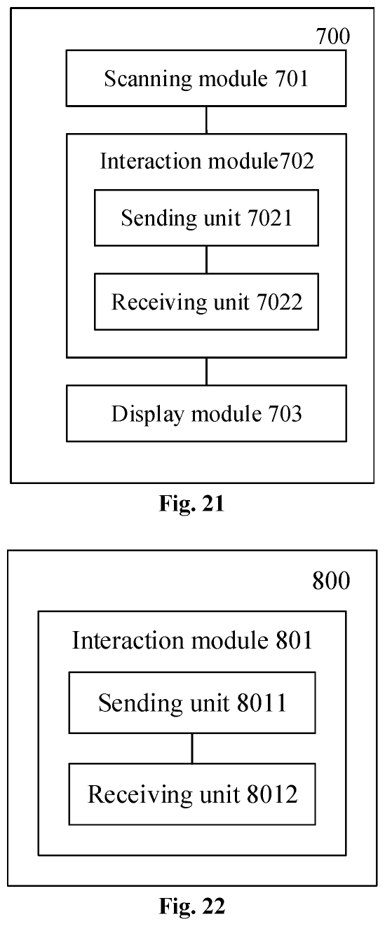

A fifth aspect of the present application provides a user terminal. FIG. 21 is a schematic structural view of an embodiment of the user terminal according to the fifth aspect of the present application. As shown in FIG. 21, the user terminal 700 may include a scanning module 701, an interaction module 702 that may include a sending unit 7021, and a display module 703. In some examples, the interaction module 702 may further include a receiving unit 7022.

The scanning module 701 may be configured to scan an information carrier pattern under a condition that a first application is called.

The interaction module 702 may be configured to access a first page address of a card binding server indicated by the scanned information carrier pattern, and send, to the card binding server, a card number of a target card indicated by the information carrier pattern, so as to trigger the card binding server to acquire user information about a target user from a back-end server of the first application.

The target user is a user logging onto the first application. The user information may include a user identifier of the target user in the first application.

In some examples, the information carrier pattern may include a QR code, and information recorded in the QR code may include the first page address and the card number of the target card.

In some other examples, the information carrier pattern may include a QR code, and information recorded in the QR code may include the first page address and an encrypted version of the card number of the target card

In some other examples, the information carrier pattern may include a surface pattern of the target card, the surface pattern may include a page jump mark and the card number of the target card, and the page jump mark corresponds to the first page address.

The interaction module 702 may be configured to receive and access a second page address sent by the card binding server.

The display module 703 may be configured to display a card binding page corresponding to a second page address.

The card binding page may include at least a part of the card number of the target card.

In some examples, the card binding page may further include one or more options of applications supported by the card binding server. Correspondingly, the card binding confirmation message may be further used to indicate selected card binding application(s), which may further include the second application. The second application may be different from the first application.

In some other examples, the card binding page may further include an area for filling in the identity information.

In some other examples, the user information may further include the identity information, and the card binding page may further include the identity information.

The sending unit 7021 may be further configured to send, in response to a user input to the card binding page, a card binding confirmation message, to the card binding server, enabling the card binding server to interact with a card issuing server and a back-end server of a card binding application by using the identity information, to complete a binding between a card identifier of the target card and a user identifier of the target user in the card binding application.

The card binding confirmation message may indicate identity information about the target user. The card binding application may include the first application.

In some examples, the card identifier may include a card number and/or a card payment identifier Token.

In the embodiments of the present application, the user terminal calls the first application to scan the information carrier pattern, to trigger the access to the first page address of the card binding server indicated by the information carrier pattern, and to send the card number of the target card indicated by the information carrier pattern to the card binding server, so as to trigger the card binding server to acquire the user information about the target user (who is a user logging onto the first application) from the back-end server of the first application. The user terminal receives and accesses the second page address corresponding to the card binding page, and displays the card binding page. The user terminal sends, to the card binding server through the card binding confirmation message, identity information confirmed by the user and a selected card binding application, so that the card binding server can complete the binding between the card identifier of the target card and the user identifier of the target user in the card binding application through the interaction with the card issuing server and the back-end server of the card binding application. It is not necessary for the user to look for a guiding entry of the card binding function in the application, and the card can be bound directly by using a scanning function of the user terminal to jump to the card binding page, thereby reducing the time required for the user to bind the card and improving the efficiency of the user using the application to bind the card.

Under a condition that the card binding includes the first application and the second application, the user terminal can send, to the card binding server through the card binding confirmation message, the identity information confirmed by the user and the selected card binding application, so that the card binding server can complete the binding between the card identifier of the target card and the user identifier of the target user in the card binding application through the interaction with the card issuing server and the back-end server of the card binding application. Card binding operations for a plurality of applications may be initiated at the same time, and it is not necessary to enter respective applications one by one to initiate the card binding operation, thereby simplifying a card binding process in a multi-application card binding scenario. Moreover, initiating the card binding operations for the plurality of applications at the same time enhances an interconnectivity among the plurality of applications in which the same card has been bound, thereby facilitating management by the user.

In some embodiments, the above sending unit 7021 may be configured to send, to the card binding server, the card number of the target card encrypted with a first key.

The card binding server may store a second key paired with the first key.

In some embodiments, the above sending unit 7021 may be further configured to send a dynamic verification code request message to the card binding server.

The above receiving unit 7022 may be further configured to receive a first dynamic verification code sent by the card binding server.

The above sending unit 7021 may be further configured to send a second dynamic verification code to the card binding server, so that the card binding server performs a verification using the first dynamic verification code and the second dynamic verification code.

In some embodiments, the above interaction module 702 may be further configured to receive and access a third page address sent by the card binding server and corresponding to a card binding result page, to display the card binding result page.

The card binding result page may be used to characterize that the binding between the card identifier of the target card and the user identifier of the target user in the card binding application has been completed.

In some embodiments, the interaction module 702 may be further configured to access a fourth page address of the card binding server.

In some embodiments, the display module 703 may be further configured to display a card binding management page corresponding to the fourth page address.

The card binding management page may include a binding relationship between the card identifier of the target card and the user identifier of the target user in the card binding application.

The sending unit 7021 may be configured to send, in response to a user input, a management operation instruction to the card binding server.

The management operation instruction may instruct the card binding server to perform a management operation on the binding relationship.

In some examples, the management operation may include one or more of a disabling operation, an enabling operation, and a payment limit setting operation.

A sixth aspect of the present application provides a server, i.e., the back-end server in the above embodiments. Under a condition that an application corresponding to the back-end server is the first application, the back-end server is the back-end server of the first application in the above embodiments, and under a condition that an application corresponding to the back-end server is the second application, the back-end server is the back-end server of the second application in the above embodiments. FIG. 22 is a schematic structural view of an embodiment of the server according to the sixth aspect of the present application. As shown in FIG. 22, the server 800 may include an interaction module 801 that may include a sending unit 8011. In some examples, the interaction module 801 may further include a receiving unit 8012.

The sending unit 8011 may be configured to send a user information about a target user to a card binding server, under a condition that an application is a first application and a card binding server accepts an access from a user terminal to a first page address indicated by the user terminal calling the first application to scan an information carrier pattern.

The target user may be a user logging onto the first application. The user information may include a user identifier of the target user in the first application.

In some examples, the information carrier pattern may include a QR code, and information recorded in the QR code may include the first page address and the card number of the target card.

In some other examples, the information carrier pattern may include a QR code, and information recorded in the QR code may include the first page address and an encrypted version of the card number of the target card.

In some other examples, the information carrier pattern may include a surface pattern of the target card, the surface pattern may include a page jump mark and the card number of the target card, and the page jump mark corresponds to the first page address.

The interaction module 801 may be configured to interact with the card binding server, to complete a binding between a card identifier of a target card and the user identifier of the target user in the first application, under a condition that the card binding server receives a card binding confirmation message.

The card binding confirmation message is sent by the user terminal in response to a user input to a card binding page, and is used to indicate identity information about the target user. The card binding page may include at least a part of the card number of the target card. The card binding application may include the first application.

In some examples, the card binding page may further include one or more options of applications supported by the card binding server.

In some other examples, the card binding page may further include an area for filling in the identity information.

In some other examples, the user information may further include the identity information, and the card binding page may further include the identity information.

In some examples, the card identifier may include a card number and/or a card payment identifier Token.

In the embodiment of the present application, under a condition that the card binding server accepts the access from the user terminal to the first page address indicated by the user terminal calling the first application to scan the information carrier pattern, the card binding server, as the back-end server of the first application, may send the user information about the target user to the card binding server. The user terminal receives and accesses the second page address corresponding to the card binding page, and displays the card binding page. The user terminal sends, to the card binding server through the card binding confirmation message, the identity information confirmed by the user and the selected card binding application, and may interact, as the back-end server of the first application, with the card binding server to complete the binding between the card identifier of the target card and the user identifier of the target user in the first application. It is not necessary for the user to look for a guiding entry of the card binding function in the application, and the card can be bound by calling the first application to scan an information carrier pattern to jump to the card binding page, thereby reducing the time required for the user to bind the card and improving the efficiency of the user using the application to bind the card.

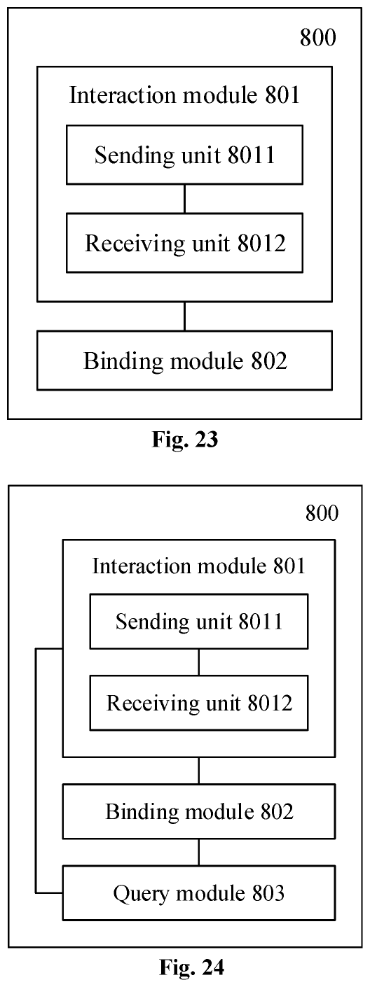

FIG. 23 is a schematic structural view of another embodiment of the server according to the sixth aspect of the present application. FIG. 23 differs from FIG. 22 in that the server 800 may further include a binding module 802.

The above receiving unit 8012 may be configured to receive a first card binding notification message sent by the card binding server, under a condition that the card binding server receives a card binding activation verification result indicating a successful card binding activation verification.

The first card binding notification message may include the card binding activation verification result information and the card identifier of the target card.

The binding module 802 may be configured to bind the card identifier of the target card with the user identifier of the target user in the first application.

In some embodiments, under a condition that the card binding page further includes one or more options of applications supported by the card binding server, the card binding confirmation message may be used to indicate selected card binding application(s) that may further include the second application. The second application may be different from the first application.

The interaction module 801 may be further configured to interact with the card binding server, to complete a binding between the card identifier of the target card and the user identifier of the target user in the second application, under a condition that the application is the second application and the card binding server receives the card binding confirmation message sent by the user terminal.

FIG. 24 is a schematic structural view of another embodiment of the server according to the sixth aspect of the present application. FIG. 24 differs from FIG. 23 in that the server 800 may further include a query module 803.

The above receiving unit 8012 may be configured to receive a card binding matching message sent by the card binding server and including the identity information.

The query module 803 may be configured to look up a user identifier matching the identity information, and determine the user identifier matching the identity information as the user identifier of the target user in the second application.

The above sending unit 8011 may be configured to send, to the card binding server, a card binding request message to request the card identifier of the target card.

The above receiving unit 8012 may be configured to receive a second card binding notification message sent by the card binding server and including the card identifier of the target card.

The binding module 803 may be configured to bind the card identifier of the target card with the user identifier of the target user in the second application.

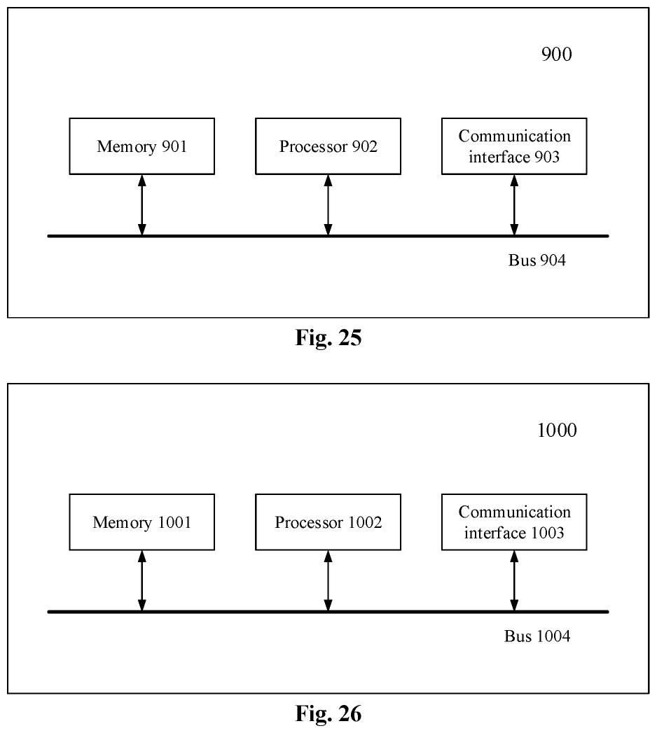

A seventh aspect of the present application further provides a server. FIG. 25 is a schematic structural view of an embodiment of the server according to the seventh aspect of the present application. As shown in FIG. 25, the server 900 includes a memory 901, a processor 902, and computer programs stored on the memory 901 and executable on the processor 902.

In one example, the above processor 902 may include a central processing unit (CPU), an application specific integrated circuit (ASIC), or one or more integrated circuits configured to implement the embodiments of the present application.

The memory 901 may include a Read-Only Memory (ROM), a Random Access Memory (RAM), a magnetic disk storage medium device, an optical storage medium device, a flash memory device, an electrical, optical or any other physical/tangible memory storage device. Accordingly, the memory generally includes one or more tangible (non-transitory) computer-readable storage media (for example, memory devices) encoded with software including computer-executable instructions, and the software, when executed (for example, by one or more processors), is operable to perform the operations described with reference to the card binding method applicable to the card binding server in the embodiments of the present application.

The processor 902 can read executable program codes stored in the memory 901 and execute computer programs corresponding to the executable program codes to implement the card binding method applicable to the card binding server in the above embodiments.

In one example, the server 900 may further include a communication interface 903 and a bus 904. As shown in FIG. 25, the memory 901, the processor 902, and the communication interface 903 are connected through the bus 904 and communicate with each other.

The communication interface 903 is mainly configured to achieve communications between/among various modules, apparatuses, units and/or devices in the embodiments of the present application. An input device and/or an output device may also be connected through the communication interface 903.

The bus 904 may include hardware, software, or both of them, and may be configured to couple various components of the server 900 to each other. For example and without limitation, the bus 904 may include an Accelerated Graphics Port (AGP) or any other graphics bus, an Enhanced Industry Standard Architecture (EISA) bus, a Front Side Bus (FSB), a Hyper Transport (HT) interconnect, an Industry Standard Architecture (ISA) bus, an infinite band interconnect, a Low Pin Count (LPC) bus, a memory bus, an Micro Channel Architecture (MCA) bus, a Peripheral Component Interconnect (PCI) bus, a PCI-Express (PCI-E) bus, a Serial Advanced Technology Attachment (SATA) bus, a Video Electronics Standards Association Local Bus (VLB) bus or any other suitable bus or any combination of two or more of the above. When appropriate, the bus 904 may include one or more buses. Although the embodiments of the present application describe and illustrate the particular bus, any suitable bus or interconnect may be considered in the present application.

An eighth aspect of the present application provides a user terminal. FIG. 26 is a schematic structural view of an embodiment of the user terminal according to the eighth aspect of the present application. As shown in FIG. 26, the user terminal 1000 includes a memory 1001, a processor 1002, and computer programs stored on the memory 1001 and executable on the processor 1002.

In one example, the above processor 1002 may include a central processing unit (CPU), an application specific integrated circuit (ASIC), or one or more integrated circuits configured to implement the embodiments of the present application.

The memory 1001 may include a Read-Only Memory (ROM), a Random Access Memory (RAM), a magnetic disk storage medium device, an optical storage medium device, a flash memory device, an electrical, optical or any other physical/tangible memory storage device. Accordingly, the memory generally includes one or more tangible (non-transitory) computer-readable storage media (for example, memory devices) encoded with software including computer-executable instructions, and the software, when executed (for example, by one or more processors), is operable to perform the operations described with reference to the card binding method applicable to the user terminal in the embodiments of the present application.

The processor 1002 can read executable program codes stored in the memory 1001 and execute computer programs corresponding to the executable program codes to implement the card binding method applicable to the user terminal in the above embodiments.

In one example, the user terminal 1000 may further include a communication interface 1003 and a bus 1004. As shown in FIG. 26, the memory 1001, the processor 1002, and the communication interface 1003 are connected through the bus 1004 and communicate with each other.

The communication interface 1003 is mainly configured to achieve communications between/among various modules, apparatuses, units and/or devices in the embodiments of the present application. An input device and/or an output device may also be connected through the communication interface 1003.

The bus 1004 may include hardware, software, or both of them, and may be configured to couple components of the user terminal 1000 to each other. For example and without limitation, the bus 1004 may include an Accelerated Graphics Port (AGP) or any other graphics bus, an Enhanced Industry Standard Architecture (EISA) bus, a Front Side Bus (FSB), a Hyper Transport (HT) interconnect, an Industry Standard Architecture (ISA) bus, an infinite band interconnect, a Low Pin Count (LPC) bus, memory bus, an Micro Channel Architecture (MCA) bus, a Peripheral Component Interconnect (PCI) bus, a PCI-Express (PCI-E) bus, a Serial Advanced Technology Attachment (SATA) bus, a Video Electronics Standards Association Local Bus (VLB) bus or any other suitable bus or any combination of two or more of the above. When appropriate, the bus 1004 may include one or more buses. Although the embodiments of the present application describe and illustrate the particular bus, any suitable bus or interconnect may be considered in the present application.

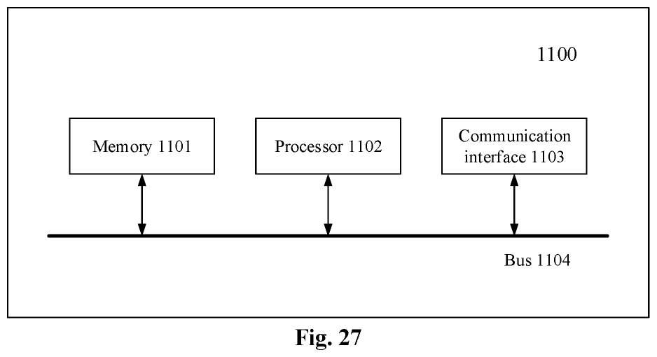

A ninth aspect of the present application provides a server. FIG. 27 is a schematic structural view of an embodiment of the server according to a ninth aspect of the present application. As shown in FIG. 27, the server 1100 includes a memory 1101, a processor 1102, and computer programs stored on the memory 1101 and executable on the processor 1102.

In one example, the above processor 1102 may include a central processing unit (CPU), an application specific integrated circuit (ASIC), or one or more integrated circuits configured to implement the embodiments of the present application.

The memory 1101 may include a Read-Only Memory (ROM), a Random Access Memory (RAM), a magnetic disk storage medium device, an optical storage medium device, a flash memory device, an electrical, optical or any other physical/tangible memory storage device. Accordingly, the memory generally includes one or more tangible (non-transitory) computer-readable storage media (for example, memory devices) encoded with software including computer-executable instructions, and the software, when executed (for example, by one or more processors), is operable to perform the operations described with reference to the card binding method applicable to the server of the application in the embodiments the present application.

The processor 1102 can read executable program codes stored in the memory 1101 and execute computer programs corresponding to the executable program codes to implement the card binding method applicable to the server of the application in the above embodiments.

In one example, the server 1100 may further include a communication interface 1103 and a bus 1104. As shown in FIG. 27, the memory 1101, the processor 1102, and the communication interface 1103 are connected through the bus 1104 and communicate with each other.

The communication interface 1103 is mainly configured to achieve communications between/among various modules, apparatuses, units and/or devices in the embodiments of the present application. An input device and/or an output device may also be connected through the communication interface 1103.

The bus 1104 may include hardware, software, or both of them, and may be configured to couple components of the server 1100 to each other. For example and without limitation, the bus 1104 may include an Accelerated Graphics Port (AGP) or any other graphics bus, an Enhanced Industry Standard Architecture (EISA) bus, a Front Side Bus (FSB), a Hyper Transport (HT) interconnect, an Industry Standard Architecture (ISA) bus, an infinite band interconnect, a Low Pin Count (LPC) bus, memory bus, an Micro Channel Architecture (MCA) bus, a Peripheral Component Interconnect (PCI) bus, a PCI-Express (PCI-E) bus, a Serial Advanced Technology Attachment (SATA) bus, a Video Electronics Standards Association Local Bus (VLB) bus or any other suitable bus or any combination of two or more of the above. When appropriate, the bus 1104 may include one or more buses. Although the embodiments of the present application describe and illustrate the particular bus, any suitable bus or interconnect may be considered in the present application.

A tenth aspect of the present application provides a card binding system that may include the card binding server, the user terminal and the server(s) of the application(s), in the above embodiments. For specific contents of the card binding server, and the user terminal and the server(s) of the application(s), as well as interactions among them, reference may be made to the relevant description in the above embodiments, which will not be repeated here.

An eleventh aspect of the present application provides a computer readable storage medium having computer program instructions stored thereon, which when executed by a processor, cause the card binding methods according to the above embodiments to be implemented, and can achieve the same technical effects, which will not be described here in order to avoid repetition. The computer-readable storage medium may include a non-transitory computer-readable storage medium such as a Read-Only Memory (ROM), a Random Access Memory (RAM), a magnetic disk or an optical disk, and the like, which is not limited herein.

It should be noted that, the embodiments in the description are described in a progressive way, and the same or similar parts of respective embodiments may reference each other. Each embodiment focuses on its differences from other embodiments. For the server embodiments, the user terminal embodiments, the system embodiments, and the computer-readable storage medium embodiments, relevant parts may reference to the description of the method embodiments. The present application is not limited to the steps and structures described above and shown in the drawings. Those skilled in the art may make various changes, modifications and additions, or change the order between steps after understanding the gist of the application. Moreover, for the sake of brevity, a detailed description of known methods and technologies is omitted herein.

Aspects of the present application are described above with reference to flowcharts and/or block diagrams of methods, apparatuses (systems) and computer program products according to the embodiments of the present application. It should be understood that, each block in the flowcharts and/or block diagrams and a combination of any of blocks in the flowcharts and/or block diagrams may be implemented by computer program instructions. These computer program instructions may be provided to a processor of a general purpose computer, a special-purpose computer, or other programmable data processing apparatus to produce a machine, so that these instructions, when executed by processor(s) of a computer or another programmable data processing apparatus, enable the implementation of the function(s)/action(s) specified in one or more blocks of the flowcharts and/or block diagrams. Such processor may be, but is not limited to, a general purpose processor, a special purpose processor, an application specific processor, or a field programmable logic circuit. It should also be understood that, each block in the block diagrams and/or the flowcharts and a combination of blocks in the block diagrams and/or the flowcharts may be implemented by special purpose hardware that can perform specified functions or actions, or by a combination of the special purpose hardware and computer instructions.

Those skilled in the art should understand that, the embodiments are all illustrative rather than restrictive. Different technical features recited in different embodiments may be combined to achieve beneficial effects. Those skilled in the art should be able to understand and implement other modified embodiments of the disclosed embodiments on the basis of studying the drawings, the description, and the claims. In the claims, the term “including” does not exclude other apparatuses or steps, the quantifier “one” does not exclude a plurality of the involved items; the terms “first” and “second” are used to indicate names and not to indicate any particular order. Any reference signs in the claims should not be construed as any limitation on the protection scope. The functions of several parts recited in the claims can be implemented by a single hardware or software module. Some technical features are recited in different dependent claims, but it does not mean that these technical features cannot be combined to obtain beneficial effects.

What is claimed is:

1-35. (canceled)

36. A card binding method applicable to a card binding server, the method comprising:
accepting an access from a user terminal to a first page address indicated by the user terminal calling a first application to scan an information carrier pattern, and acquiring a card number of a target card indicated by the information carrier pattern;
acquiring user information about a target user from a back-end server of the first application, wherein the target user is a user logging onto the first application, and the user information comprises a user identifier of the target user in the first application;
sending, to the user terminal, a second page address corresponding to a redirected card binding page, wherein the card binding page comprises at least a part of the card number of the target card;
receiving a card binding confirmation message indicating identity information about the target user, wherein the card binding confirmation message is sent by the user terminal based on the card binding page; and
interacting with a card issuing server and a back-end server of a card binding application by using the identity information, to complete a binding between a card identifier of the target card and a user identifier of the target user in the card binding application, wherein the card binding application comprises the first application.

37. The method according to claim 36, wherein
the information carrier pattern comprises a Quick Response (QR) code, and information recorded in the QR code comprises the first page address and the card number of the target card, or the information recorded in the QR code comprises the first page address and an encrypted version of the card number of the target card; or
the information carrier pattern comprises a surface pattern of the target card, and the surface pattern comprises a page jump mark and the card number of the target card, and the page jump mark corresponds to the first page address.

38. The method according to claim 36, wherein interacting with the card issuing server and the back-end server of the card binding application by using the identity information, to complete the binding between the card identifier of the target card and the user identifier of the target user in the card binding application, comprises:
sending, to the card issuing server, a card binding activation message comprising the card number of the target card and the identity information, enabling the card issuing server to perform a card binding activation verification using the identity information;
receiving card binding activation verification result information sent by the card issuing server; and
under a condition that the card binding activation verification result information indicates a successful card binding activation verification, sending a first card binding notification message to the back-end server of the first application, wherein the first card binding notification message comprises the card binding activation verification result information and the card identifier of the target card, so that the back-end server of the first application completes a binding between the card identifier of the target card and the user identifier of the target user in the first application.

39. The method according to claim 36, wherein the card binding page further comprises one or more options of applications supported by the card binding server, the card binding confirmation message is further used to indicate a selected card binding application, and the card binding application further comprises a second application; and
interacting with the card issuing server and the back-end server of the card binding application by using the identity information, to complete the binding between the card identifier of the target card and the user identifier of the target user in the card binding application, further comprises:
sending, to a back-end server of the second application, a card binding matching message comprising the identity information, so that the back-end server of the second application looks up a user identifier matching the identity information;
under a condition that the user identifier matching the identity information is found, receiving a card binding request message sent by the back-end server of the second application, wherein the card binding request message is used to request the card identifier of the target card; and
sending, to the back-end server of the second application, a second card binding notification message comprising the card identifier of the target card, so that the back-end server of the second application completes a binding between the card identifier of the target card and a user identifier of the target user in the second application, wherein the user identifier of the target user in the second application is a user identifier matching the identity information.

40. The method according to claim 36, wherein
the card binding page further comprises an area for filling an identity information; or
the user information further comprises the identity information, and the card binding page further comprises the identity information.

41. The method according to claim 36, wherein acquiring the card number of the target card from the user terminal comprises:
receiving the card number of the target card, sent by the user terminal and encrypted with a first key; and
decrypting the encrypted card number of the target card using a pre-stored second key paired with the first key, to obtain the card number of the target card.

42. The method according to claim 36, before interacting with the card issuing server and the back-end server of the card binding application by using the identity information, to complete the binding between the card identifier of the target card and the user identifier of the target user in the card binding application, the method further comprising:
receiving a dynamic verification code request message sent by the user terminal;
sending a first dynamic verification code to the user terminal;
receiving a second dynamic verification code sent by the user terminal;
interacting with the card issuing server and the back-end server of the card binding application by using the identity information, to complete the binding between the card identifier of the target card and the user identifier of the target user in the card binding application, comprises:
under a condition that the first dynamic verification code coincides with the second dynamic verification code, interacting with the card issuing server and the back-end server of the card binding application by using the identity information, to complete the binding between the card identifier of the target card and the user identifier of the target user in the card binding application.

43. The method according to claim 36, after accepting the access from the user terminal to the first page address through the first application and acquiring the card number of the target card from the user terminal, the method further comprising:
determining whether the first application belongs to applications supported by the card binding server; and
acquiring the user information about the target user from the back-end server of the first application, comprising:
under a condition that the first application belongs to the applications supported by the card binding server, acquiring the user information about the target user from the back-end server of the first application.

44. The method according to claim 36, after interacting with the card issuing server and the back-end server of the card binding application by using the identity information, to complete the binding between the card identifier of the target card and the user identifier of the target user in the card binding application, the method further comprising:
sending a third page address corresponding to a redirected card binding result page to the user terminal, wherein the card binding result page is used to characterize that the binding between the card identifier of the target card and the user identifier of the target user in the card binding application has been completed; and
accepting the access from the user terminal to the third page address.

45. The method according to claim 36, further comprising:
accepting an access from the user terminal to a fourth page address corresponding to a card binding management page, wherein the card binding management page comprises a binding relationship between the card identifier of the target card and the user identifier of the target user in the card binding application; and
receiving a management operation instruction of the user terminal to perform a management operation on a binding relationship indicated by the management operation instruction,
wherein the management operation comprises one or more of a disabling operation, an enabling operation, and a payment limit setting operation.

46. A card binding method applicable to a user terminal, the method comprising:
calling a first application to scan an information carrier pattern, accessing a first page address of a card binding server indicated by the information carrier pattern, and sending a card number of a target card indicated by the information carrier pattern to the card binding server, so as to trigger the card binding server to acquire user information about a target user from a back-end server of the first application, wherein the target user is a user logging onto the first application, and the user information comprises a user identifier of the target user in the first application;
receiving and accessing a second page address sent by the card binding server, to display a card binding page corresponding to the second page address and comprising at least a part of the card number of the target card;
sending, in response to a user input to the card binding page, a card binding confirmation message indicating identity information about the target user, to the card binding server, enabling the card binding server to interact with a card issuing server and a back-end server of a card binding application by using the identity information, to complete a binding between a card identifier of the target card and a user identifier of the target user in the card binding application, wherein the card binding application comprises the first application.

47. The method according to claim 46, wherein
the card binding page further comprises one or more options of applications supported by the card binding server, the card binding confirmation message is further used to indicate a selected card binding application, and the card binding application further comprises a second application.

48. The method according to claim 46, after receiving and accessing the second page address sent by the card binding server, the method further comprising:
sending a dynamic verification code request message to the card binding server;
receiving a first dynamic verification code sent by the card binding server; and
sending a second dynamic verification code to the card binding server, so that the card binding server performs a verification using the first dynamic verification code and the second dynamic verification code.

49. The method according to claim 46, further comprising:
receiving and accessing a third page address sent by the card binding server and corresponding to a card binding result page to display the card binding result page, wherein the card binding result page is used to characterize that the binding between the card identifier of the target card and the user identifier of the target user in the card binding application has been completed.

50. The method according to claim 46, further comprising:
accessing a fourth page address of the card binding server to display a card binding management page corresponding to the fourth page address, wherein the card binding management page comprises a binding relationship between the card identifier of the target card and the user identifier of the target user in the card binding application; and
sending, in response to a user input, a management operation instruction to the card binding server, wherein the management operation instruction instructs the card binding server to perform a management operation on the binding relationship,
wherein the management operation comprises one or more of a disabling operation, an enabling operation, and a payment limit setting operation.

51. A card binding method applicable to a back-end server of an application, the method comprising:
under a condition that the application is a first application, and a card binding server accepts an access from a user terminal to a first page address indicated by the user terminal calling the first application to scan an information carrier pattern scanned by calling the first application, sending a user information about a target user to the card binding server, wherein the target user is a user logging on to the first application, and the user information comprises a user identifier of the target user in the first application; and
under a condition that the card binding server receives a card binding confirmation message, interacting with the card binding server to complete a binding between a card identifier of a target card and the user identifier of the target user in the first application, wherein the card binding confirmation message is sent by the user terminal in response to a user input to a card binding page and is used to indicate identity information about the target user, the card binding page comprises at least a part of a card number of the target card, and a card binding application comprises the first application.

52. The method according to claim 51, wherein interacting with the card binding server to complete the binding between the card identifier of the target card and the user identifier of the target user in the first application comprises:
under a condition that the card binding server receives a card binding activation verification result indicating a successful card binding activation verification, receiving a first card binding notification message sent by the card binding server, wherein the first card binding notification message comprises the card binding activation verification result information and the card identifier of the target card; and
binding the card identifier of the target card with the user identifier of the target user in the first application.

53. The method according to claim 51, wherein the card binding page further comprises one or more options of applications supported by the card binding server, the card binding confirmation message is further used to indicate a selected card binding application, and the card binding application further comprises a second application; and
the method further comprises:
under a condition that the application is the second application and the card binding server receives the card binding confirmation message sent by the user terminal, interacting with the card binding server to complete a binding between the card identifier of the target card and the user identifier of the target user in the second application.

54. The method according to claim 53, wherein interacting with the card binding server to complete the binding between the card identifier of the target card and the user identifier of the target user in the second application comprises:
receiving a card binding matching message sent by the card binding server and comprising the identity information;
looking up a user identifier matching the identity information, and determining the user identifier matching the identity information as the user identifier of the target user in the second application;
sending, to the card binding server, a card binding request message to request the card identifier of the target card;
receiving a second card binding notification message sent by the card binding server and comprising the card identifier of the target card; and
binding the card identifier of the target card with the user identifier of the target user in the second application.

55. A non-transitory computer readable storage medium having computer program instructions stored thereon, which when executed by a processor, cause the card binding method according to claim 36 to be implemented.
